(19) United States
(12) Patent Application Publication
(10) Pub. No.: US 2026/0237344 A1
(43) Pub. Date: Aug. 13, 2026

(54) DISPLAY APPARATUS AND METHOD FOR CONTROLLING LEDS BASED ON TEMPERATURE CONDITIONS

(71) Applicant: SAMSUNG ELECRONICS CO., LTD., Suwon-si (KR)

(72) Inventors: Sujin KIM, Suwon-si (KR); Jungmo KANG, Suwon-si (KR); Myungjoon KIM, Suwon-si (KR); Seungyong SHIN, Suwon-si (KR)

(73) Assignee: SAMSUNG ELECRONICS CO., LTD., Suwon-si (KR)

(21) Appl. No.: 19/394,216

(22) Filed: Nov. 19, 2025

Related U.S. Application Data
(63) Continuation of application No. PCT/KR2025/016554, filed on Oct. 20, 2025.

(30) Foreign Application Priority Data
Feb. 11, 2025 (KR) 10-2025-0017603

(51) Int. Cl. G09G 3/32; G09G 3/34

(52) U.S. Cl. CPC G09G 3/32; G09G 3/3426; G09G 2320/0233; G09G 2320/041; G09G 2320/066

(57) ABSTRACT

A display apparatus including a chassis having a first area and a second area. The display apparatus including one or more circuit boards mounted on the chassis in the first area and configured to drive the display apparatus. The display apparatus including a backlight unit arranged on the chassis and comprising a plurality of light-emitting diodes (LEDs) including one or more first LEDs arranged on the first area and a second LED arranged on the second area. The display apparatus including at least one processor configured to determine driving data based on input data and the driving algorithm. The at least one processor configured to, based on the driving data, determine a first driving current applied to the one or more first LEDs and a second driving current applied to the second LED. The at one processor configured to adjust the first driving current by applying the compensation algorithm..

### CROSS-REFERENCE TO RELATED APPLICATIONS

This application is continuation of an International Application No. PCT/KR2025/016554, filed on Oct. 20, 2025, which claims benefit of Korean Application No. 10-2025-0017603, filed on Feb. 11, 2025, at the Korean Intellectual Property Office, the disclosure of which are incorporated herein in their entireties by reference.

### BACKGROUND

### Field

The disclosure relates to a display apparatus and a method for controlling light-emitting diodes based on temperature conditions, and more particularly, to a display apparatus capable of compensating for deterioration of a plurality of light-emitting diodes and a method of controlling the display apparatus.

### Description of the Related Art

In general, display apparatuses are a type of output device for visually displaying obtained or stored image information to a user, and are used in various fields such as the home or workplace.

A display apparatus includes a backlight unit (BLU) that provides light to a liquid crystal panel, and the BLU includes a plurality of light emitters (light-emitting devices) that may independently emit light. The light emitter includes, for example, a light-emitting diode (LED) or an organic light-emitting diode (OLED).

Depending on the type, a display apparatus may include a display panel that displays an image without a BLU. The display panel includes a plurality of LEDs that may independently emit light, and the plurality of LEDs include a red LED, a green LED, and a blue LED.

Performance of an LED may be reduced by a deterioration phenomenon. Because red, green, and blue LEDs have different physical properties and materials, the degree of performance deterioration may vary.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided is a display apparatus that may compensate for performance reduction due to a deterioration phenomenon of a LED, and a method of controlling the display apparatus.

Further provided is a display apparatus that may compensate for performance reduction due to a deterioration phenomenon based on different criteria for each type of LED, and a method of controlling the display apparatus.

Further provided is a display apparatus that may rapidly recover performance of an LED by minimizing heat generated from the LED when the performance of the LED deteriorates, and a method of controlling the display apparatus.

Further provided is a display apparatus that may effectively compensate for LED deterioration caused by heat generated from a circuit board for driving the display apparatus, and a method of controlling the display apparatus.

Technical aspects that can be achieved by the disclosure are not limited to the above-mentioned aspects, and other technical aspects not mentioned will be clearly understood by one of ordinary skill in the technical art to which the disclosure belongs from the following description.

According to an embodiment of the disclosure, a display apparatus includes a chassis having a first area and a second area. The display apparatus includes one or more circuit boards mounted on the chassis in the first area and configured to drive the display apparatus. The one or more circuit boards is not mounted in the second area. The display apparatus includes a backlight unit arranged on the chassis and comprising a plurality of light-emitting diodes (LEDs) including one or more first LEDs arranged on the first area and a second LED arranged on the second area. The display apparatus includes memory configured to store a driving algorithm for driving the plurality of LEDs and a compensation algorithm for compensating for deterioration of the one or more first LEDs of the plurality of LEDs due to heat generation of the one or more circuit boards. The display apparatus includes at least one processor configured to: determine driving data based on input data and the driving algorithm, based on the driving data, determine a first driving current applied to the one or more first LEDs and a second driving current applied to the second LED, and adjust the first driving current by applying the compensation algorithm based on a turn-on period of the display apparatus having exceeded a defined period.

In an embodiment, in the adjusting the first driving current, the at least one processor is further configured to increase a correction rate of an amplitude of the first driving current as a temperature of the one or more circuit boards corresponding to the turn-on period of the display apparatus increases to a defined saturation temperature.

In an embodiment, the at least one processor is further configured to maintain the correction rate of the amplitude of the first driving current at a defined maximum correction rate. Maintaining the correction rate is based on the temperature of the one or more circuit boards corresponding to the turn-on period of the display apparatus being greater than or equal to the defined saturation temperature.

In an embodiment, the one or more first LEDs comprises a first red LED, a first green LED, and a first blue LED, an increase coefficient of the correction rate of the amplitude according to an increase in the temperature of the one or more circuit boards includes a first increase coefficient corresponding to the first red LED, a second increase coefficient corresponding to the first green LED, and a third increase coefficient corresponding to the first blue LED, and the first increase coefficient is greater than the second increase coefficient, and the second increase coefficient is greater than the third increase coefficient.

In an embodiment, in the adjusting the first driving current, the at least one processor is further configured to decrease a duty ratio of the first driving current as a temperature of the one or more circuit boards corresponding to the turn-on period of the display apparatus increases to a defined saturation temperature.

In an embodiment, the at least one processor is further configured to: adjust the duty ratio of the first driving current to a defined lowest duty ratio, based on the temperature of the one or more circuit boards corresponding to the turn-on period of the display apparatus reaching the defined saturation temperature, and increase the duty ratio of the first driving current as the temperature of the one or more circuit boards corresponding to the turn-on period of the display apparatus increases from the defined saturation temperature.

In an embodiment, the one or more first LEDs comprises a first red LED, a first green LED, and a first blue LED, a decrease coefficient of the duty ratio according to an increase in the temperature of the one or more circuit boards includes a first decrease coefficient corresponding to the first red LED, a second decrease coefficient corresponding to the first green LED, and a third decrease coefficient corresponding to the first blue LED, andthe first decrease coefficient is greater than the second decrease coefficient, and the second decrease coefficient is greater than the third decrease coefficient.

In an embodiment, the one or more first LEDs comprises a first red LED, a first green LED, and a first blue LED, the defined lowest duty ratio includes a first duty ratio corresponding to the first red LED, a second duty ratio corresponding to the first green LED, and a third duty ratio corresponding to the first blue LED, and the first duty ratio is less than the second duty ratio, and the second duty ratio is less than the third duty ratio.

In an embodiment, the one or more first LEDs comprises a first red LED, a first green LED, and a first blue LED, the defined saturation temperature includes a first saturation temperature corresponding to the first red LED, a second saturation temperature corresponding to the first green LED, and a third saturation temperature corresponding to the first blue LED, and the first saturation temperature is lower than the second saturation temperature, and the second saturation temperature is lower than the third saturation temperature.

In an embodiment, the one or more circuit boards comprises a first circuit board and a second circuit board, the first area includes a third area where the first circuit board is mounted and a fourth area where the second circuit board is mounted, the one or more first LEDs comprises a third LED arranged on the third area and a fourth LED arranged on the fourth area, the compensation algorithm includes a first compensation algorithm corresponding to the third area and a second compensation algorithm corresponding to the fourth area, and the first compensation algorithm and the second compensation algorithm are defined differently from each other based on differences in heat generation characteristics of the third area and the fourth area.

In an embodiment, the at least one processor is further configured to: based on the driving data, determine a third driving current applied to the third LED and a fourth driving current applied to the fourth LED, adjust the determined third driving current by applying the first compensation algorithm based on the turn-on period of the display apparatus having exceeded a first defined period, and adjust the determined fourth driving current by applying the second compensation algorithm based on the turn-on period of the display apparatus having exceeded a second defined period. The first defined period and the second defined period are defined differently based on differences in heat generation characteristics of the third area and the fourth area.

In an embodiment, the driving algorithm includes a dedicated algorithm for compensating for deterioration of the plurality of LEDs due to heat generation of the plurality of LEDs.

In an embodiment, the compensation algorithm comprises: an estimation algorithm for estimating a temperature of the one or more circuit boards based on the turn-on period of the display apparatus; and an adjustment algorithm for adjusting an amplitude and a duty ratio of the first driving current based on the estimated temperature of the one or more circuit boards.

In an embodiment, the compensation algorithm is used to adjust only the first driving current among the first driving current and the second driving current.

According to an embodiment of the disclosure, a method for controlling a display apparatus including a chassis having a first area and a second area; a circuit board mounted on the chassis in the first area and configured to drive the display apparatus, and a backlight unit arranged on the chassis and including a plurality of light-emitting diodes (LEDs) including one or more first LEDs arranged on the first area and a second LED arranged on the second area. The circuit board is not mounted in the second area. The method includes determining driving data based on input data and a driving algorithm. The method includes, based on the driving data, determining a first driving current applied to the one or more first LEDs and a second driving current applied to the second LED. The method includes adjusting the first driving current by applying a compensation algorithm based on a turn-on period of the display apparatus having exceeded a defined period.

In an embodiment, the adjusting of the first driving current comprises increasing a correction rate of an amplitude of the first driving current as a temperature of the one or more circuit boards corresponding to the turn-on period of the display apparatus increases to a defined saturation temperature.

In an embodiment, the adjusting of the first driving current further comprises maintaining the correction rate of the amplitude of the first driving current at a defined maximum correction rate, wherein maintaining the correction rate is based on the temperature of the one or more circuit boards corresponding to the turn-on period of the display apparatus being greater than or equal to the defined saturation temperature.

In an embodiment, the adjusting of the first driving current comprises decreasing a duty ratio of the first driving current as a temperature of the one or more circuit boards corresponding to the turn-on period of the display apparatus increases to a defined saturation temperature.

In an embodiment, the adjusting of the first driving current further comprises adjusting the duty ratio of the first driving current to a defined lowest duty ratio, based on the temperature of the one or more circuit boards corresponding to the turn-on period of the display apparatus reaching the defined saturation temperature. In an embodiment, the adjusting of the first driving current further comprises increasing the duty ratio of the first driving current as the temperature of the one or more circuit boards corresponding to the turn-on period of the display apparatus increases from the defined saturation temperature.

In an embodiment, the one or more circuit boards comprises a first circuit board and a second circuit board, the first area includes a third area where the first circuit board is mounted and a fourth area where the second circuit board is mounted, the one or more first LEDs comprises a third LED arranged on the third area and a fourth LED arranged on the fourth area, the compensation algorithm includes a first compensation algorithm corresponding to the third area and a second compensation algorithm corresponding to the fourth area, the determining of the first driving current comprises determining a third driving current applied to the third LED and a fourth driving current applied to the fourth LED, and the adjusting of the first driving current comprises: adjusting the determined third driving current by applying the first compensation algorithm based on the turn-on period of the display apparatus having exceeded the first defined period, and adjusting the determined fourth driving current by applying the second compensation algorithm based on the turn-on period of the display apparatus having exceeded the second defined period.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 illustrates an example of an appearance of a display apparatus according to an embodiment.

FIG. 2 illustrates an example of a configuration of a display apparatus according to an embodiment.

FIG. 3 illustrates an example of a liquid crystal panel included in a display apparatus according to an embodiment.

FIG. 4 illustrates an example of a BLU included in a display apparatus according to an embodiment.

FIG. 5 is a diagram illustrating that a plurality of LEDs of a BLU may be divided into dimming blocks according to an embodiment.

FIG. 6 is a control block diagram of a display apparatus according to an embodiment.

FIG. 7 illustrates an example in which a display apparatus converts image data into dimming data according to an embodiment.

FIG. 8 illustrates an example of a light emitter included in a BLU according to an embodiment.

FIG. 9 illustrates an example of a circuit board mounted on a chassis of a display apparatus according to an embodiment.

FIG. 10 is a diagram illustrating LEDs arranged on deterioration areas of a chassis of a display apparatus according to an embodiment.

FIG. 11 illustrates components for controlling a driving current flowing through a light emitter according to an embodiment.

FIG. 12 is a conceptual diagram illustrating that a controller controls an LED according to an embodiment.

FIG. 13 is a flowchart illustrating an example method of controlling a display apparatus according to an embodiment.

FIG. 14 illustrates an example of an estimation algorithm for estimating a temperature change of a deterioration area according to a turn-on period of a display apparatus in a compensation algorithm used by the display apparatus according to an embodiment.

FIG. 15 illustrates an example of an adjustment algorithm for adjusting a correction rate of an amplitude according to a temperature change of a deterioration area in a compensation algorithm used by a display apparatus according to an embodiment.

FIG. 16 illustrates an example of an adjustment algorithm for adjusting a duty ratio according to a temperature change of a deterioration area in a compensation algorithm used by a display apparatus according to an embodiment.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

It will be understood that if a certain component is referred to as being “coupled with,” “coupled to,” “supported on” or “in contact with” another component, it refers to that the component may be coupled with the other component directly or indirectly via a third component.

It will also be understood that when an element is referred to as being “on” another element, it may be directly on the other element or intervening elements may also be present.

Hereinafter, embodiments of the disclosure will be described in detail with reference to the accompanying drawings.

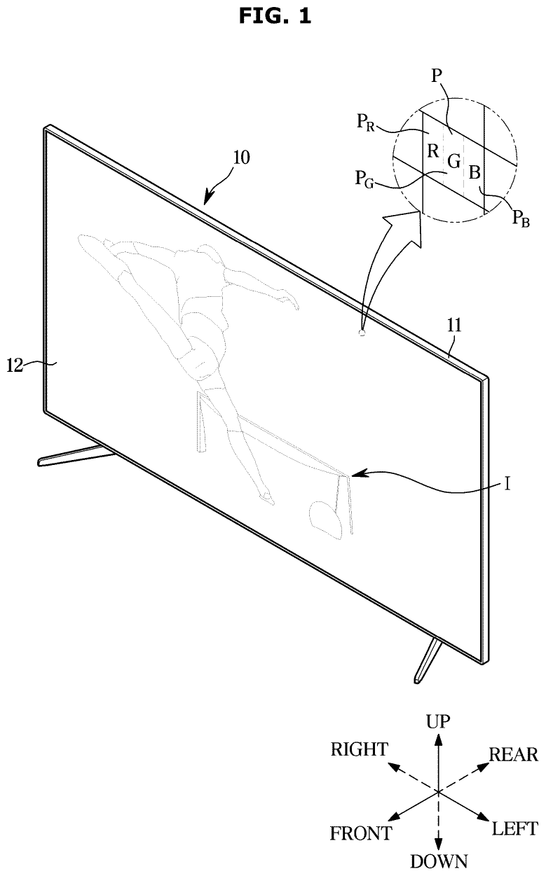

FIG. 1 illustrates an example of an appearance of a display apparatus according to an embodiment.

Referring to FIG. 1, a display apparatus 10 is a device capable of processing an image signal received from the outside and visually displaying a processed image. Hereinafter, a case in which the display apparatus 10 is a television (TV) is exemplified, but is not limited thereto. For example, the display apparatus 10 may be implemented in various forms, such as a monitor, a portable multimedia device, a portable communication device, and the like, and the form of the display apparatus 10 is not limited as long as it is a device that visually displays an image.

In addition, the display apparatus 10 may be a large format display (LFD) installed outdoors, such as a building rooftop or a bus stop. Here, the outdoors is not necessarily limited to an outdoor space, and the display apparatus 10 according to an embodiment may be installed wherever a large number of people may come and go, even indoors such as at subway stations, shopping malls, movie theaters, office buildings, and stores.

The display apparatus 10 may receive content including a video signal and an audio signal from various content sources, and output video and audio corresponding to the video signal and the audio signal, respectively. For example, the display apparatus 10 may receive content data through a broadcast reception antenna or a wired cable, receive content data from a content playback apparatus, or receive content data from a content-providing server of a content provider.

As shown in FIG. 1, the display apparatus 10 may include a main body 11 and a screen 12 for displaying an image I.

The main body 11 forms an exterior of the display apparatus 10, and components for the display apparatus 10 to display the image I or perform various functions may be provided inside the main body 11. The main body 11 shown in FIG. 1 has a flat plate shape, but the shape of the main body 11 is not limited to that shown in FIG. 1. For example, the main body 11 may have a curved plate shape.

The screen 12 is formed on a front surface of the main body 11, and may display the image I. For example, the screen 12 may display a still image or a video. In addition, the screen 12 may display a two-dimensional plane image or a three-dimensional stereoscopic image using binocular parallax of a user.

The screen 12 may include a liquid crystal panel capable of transmitting or blocking light emitted by a BLU, or the like.

A plurality of pixels P may be formed on the screen 12, and the image I displayed on the screen 12 may be formed by light emitted from each of the plurality of pixels P. For example, the image I may be formed on the screen 12 by combining light emitted from each of the plurality of pixels P like a mosaic.

Each of the plurality of pixels P may emit light of various brightness and various colors. In order to emit light of various colors, each of the plurality of pixels P may include sub-pixels PR, PG, and PB.

The sub-pixels PR, PG, and PB may include a red sub-pixel PR capable of emitting red light, a green sub-pixel PG capable of emitting green light, and a blue sub-pixel PB capable of emitting blue light. For example, the red light may represent light having a wavelength of approximately 700 nm to 800 nm. The green light may represent light having a wavelength of approximately 500 nm to 600 nm. The blue light may represent light having a wavelength of approximately 400 nm to 500 nm.

By combining the red light of the red sub-pixel PR, the green light of the green sub-pixel PG, and the blue light of the blue sub-pixel PB, light of various brightness and various colors may be emitted from each of the plurality of pixels P.

According to various embodiments, in a case where the display apparatus 10 is a self-emissive display apparatus, a backlight unit itself may include a red LED that outputs red light, a green LED that outputs green light, and a blue LED that outputs blue light, and may be used as a display panel. According to various embodiments, in a case where the display apparatus 10 is a self-emissive display apparatus, the display apparatus 10 may not include a liquid crystal panel.

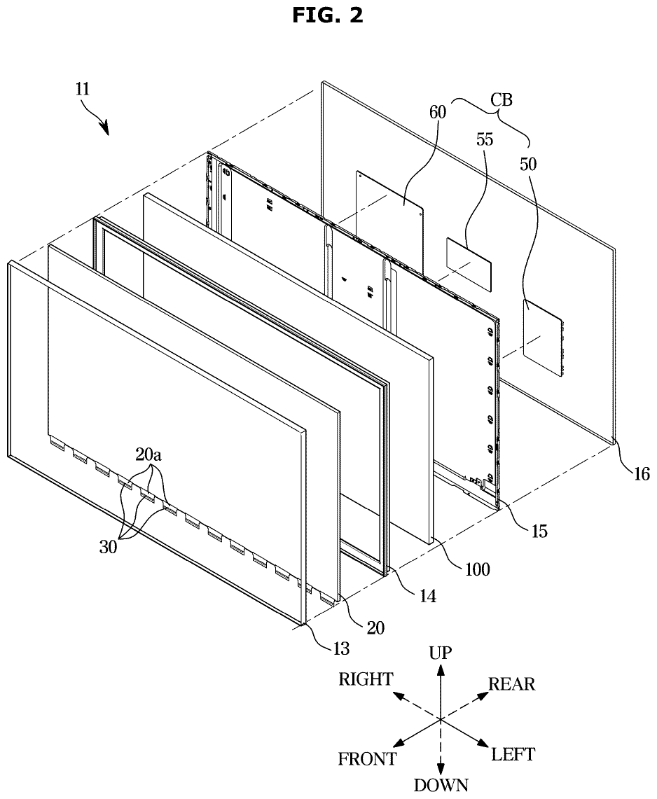

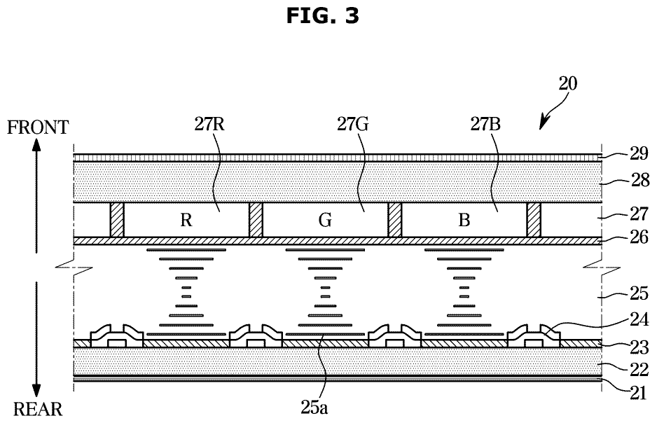

FIG. 2 illustrates an example of a configuration of a display apparatus according to an embodiment, and FIG. 3 illustrates an example of a liquid crystal panel included in a display apparatus according to an embodiment.

As shown in FIG. 2, various components for generating an image I on the screen 12 may be provided in the main body 11.

For example, the main body 11 may include a backlight unit 100 which is a surface light source, a liquid crystal panel 20 blocking or transmitting light emitted from the backlight unit 100, a control board 50 controlling operations of the backlight unit 100 and the liquid crystal panel 20, and a power board 60 supplying power to the backlight unit 100 and the liquid crystal panel 20. In addition, the main body 11 may include a bezel 13, a frame middle mold 14, a bottom chassis 15, and a rear cover 16 for supporting the liquid crystal panel 20, the backlight unit 100, and a circuit board CB.

In an embodiment, the circuit board CB may be mounted on the chassis 15. For example, the circuit board CB may be mounted on a rear surface of the chassis 15, and may not be exposed to the outside of the display apparatus 10 by the rear cover 16.

In the disclosure, the chassis 15 may refer to a component on which the circuit board CB may be mounted, and may also be referred to as a board substrate, a board plate, or the like, in that the circuit board CB is mounted.

The circuit board CB may be implemented with a printed circuit board and various circuits mounted on the printed circuit board. For example, the power circuit may include a condenser, a coil, a resistance element, a processor, and the like, and a power circuit board on which these elements are mounted. In addition, the control circuit may include a memory, a processor, and a control circuit board on which these elements are mounted.

The circuit board CB where electronic circuits and various electrical components are mounted may perform the function of controlling and supplying electrical signals and power required to drive the display apparatus 10, as a component of the display apparatus 10 for driving the display apparatus 10.

In general, on the circuit board CB, a conductive wiring pattern is formed on an insulator substrate, and various electrical and electronic components mounted are electrically connected to each other through the wiring pattern.

The circuit board CB may include various types of integrated circuits (IC) and electronic devices for performing various functions of the display apparatus 10, such as driving the liquid crystal panel 20, controlling the backlight unit 100, and processing image signals. Heat is inevitably generated during the operation of these electrical and electronic components, and the generated heat may affect surrounding components.

In particular, in a case where a light emitter 111, such as an LED 190, is disposed near the circuit board CB, the heat generated from the circuit board CB may adversely affect the light-emitting characteristics of the LED 190. Because the LED 190 has characteristics that its light-emitting efficiency decreases and its lifespan shortens as the temperature rises, minimizing or compensating for the impact of heat generated by the circuit board CB improves the image quality uniformity and reliability of the display apparatus 10.

In an embodiment, the circuit board CB may be replaced with various terms, such as a circuit substrate, a printed circuit board, an electronic circuit board, an electrical circuit board, a driving circuit board, a control circuit board, electrical components, an electrical circuit device, a circuit mounting board, or the like.

In an embodiment, the circuit board CB may include the main control board 50 configured to control the overall operation of the display apparatus 10 (e.g., the operation of the liquid crystal panel 20 and/or the backlight unit 100), a BLU control board 55 configured to control the operation of the backlight unit 100, and/or the power board 60 configured to convert external power to the voltage required by each component of the display apparatus 10 (e.g., the main control board 50 and/or the BLU control board 55) and supplies the voltage to each component of the display apparatus 10.

The main control board 50 is a core circuit board that acts as the brain of the display apparatus 10, and may process input data (e.g., video signals) input from the outside and convert the input data into a form suitable for the liquid crystal panel 20. In addition, the main control board 50 may include a main processor configured to control the overall operation of the display apparatus 10, a memory configured to temporarily store image data, and various interface circuits.

The main control board 50 may process input data (e.g., video signals) and convert the input data to a form (e.g., dimming data) suitable for driving the backlight unit 100. The main control board 50 may transmit dimming data for local dimming to the BLU control board 55.

The BLU control board 55 may control the driving of the LED 190. The BLU control board 55 may include a pulse width modulation (PWM) control circuit for controlling the LED 190, a pulse amplitude modulation (PAM) control circuit, a current detection circuit for detecting the current flowing through the LED 190, and the like.

The BLU control board 55 may control the driving current flowing through the LED 190 based on a control signal received from the main control board 50, and may perform a local dimming operation, which will be described below.

The power board 60 may include an alternating current-direct current (AC-DC) converter, a DC-DC converter, various voltage regulators, and/or overvoltage and overcurrent protection circuits. The power board 60 may supply power to components of the display apparatus 10, such as the main control board 50, the BLU control board 55, the liquid crystal panel 20, and the backlight unit 100.

The heat generation characteristics and temperature distribution of the circuit board CB may vary depending on its type and function, and may differently affect the performance of the LED 190 disposed nearby.

For example, when the display apparatus 10 is turned on, the LED 190 disposed on the area corresponding to the area where the circuit board CB is mounted may heat up faster than the LED 190 disposed on the area corresponding to the area where the circuit board CB is not mounted.

In another example, when the display apparatus 10 is turned on, the temperature may rise in the order of the power board 60, the main control board 50, and the BLU control board 55.

According to various embodiments, the circuit boards CB described above may be integrated into at least one board. For example, the main control board 50 and the BLU control board 55 may be implemented as a single integrated board.

The backlight unit 100 may include a point light source that emits white light. In addition, the backlight unit 100 may refract, reflect, and scatter the light to convert the light emitted from the point light source into a uniform surface light. As described above, the backlight unit 100 may refract, reflect, and scatter the light emitted from the point light source to emit a uniform surface light in a forward direction.

The backlight unit 100 may be referred to as a light source apparatus in that the backlight unit 100 is a component for emitting light. The backlight unit 100 will be described in more detail below.

The liquid crystal panel 20 is provided in front of the backlight unit 100, and blocks or transmits light emitted from the backlight unit 100 to form the image I.

A front surface of the liquid crystal panel 20 forms the screen 12 of the display apparatus 10 described above, and the liquid crystal panel 20 may form the plurality of pixels P. The plurality of pixels P of the liquid crystal panel 20 may independently block or transmit the light of the backlight unit 100. In addition, the light transmitted by the plurality of pixels P may form the image I to be displayed on the screen 12.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the thin film transistor 24, the liquid crystal layer 25, the common electrode 26, and the color filter 27. The first and second transparent substrates 22 and 28 may be formed of tempered glass or transparent resin.

The first polarizing film 21 and the second polarizing film 29 are provided on outer sides of the first and second transparent substrates 22 and 28. The first polarizing film 21 and the second polarizing film 29 may each transmit specific polarized light and block (reflect or absorb) the other polarized light. For example, the first polarizing film 21 may transmit light polarized in a first direction and block (reflect or absorb) the other polarized light. In addition, the second polarizing film 29 may transmit light polarized in a second direction and block (reflect or absorb) the other polarized light. In this instance, the first direction and the second direction may be orthogonal to each other. Thus, the polarized light passing through the first polarizing film 21 may not directly pass through the second polarizing film 29.

The color filter 27 may be provided on an inner side of the second transparent substrate 28. The color filter 27 may include, for example, a red filter 27R transmitting red light, a green filter 27G transmitting green light, and a blue filter 27B transmitting blue light. In addition, the red filter 27R, the green filter 27G, and the blue filter 27B may be arranged side by side. A region occupied by the color filter 27 corresponds to the pixel P described above. A region occupied by the red filter 27R corresponds to the red sub-pixel PR, a region occupied by the green filter 27G corresponds to the green sub-pixel PG, and a region occupied by the blue filter 27B corresponds to the blue sub-pixel PB.

The pixel electrode 23 may be provided on an inner side of the first transparent substrate 22, and the common electrode 26 may be provided on the inner side of the second transparent substrate 28. The pixel electrode 23 and the common electrode 26 may be formed of a metal material through which electricity is conducted, and may generate an electric field for changing the arrangement of liquid crystal molecules 25a constituting the liquid crystal layer 25 to be described below.

The thin film transistor (TFT) 24 is provided on the inner side of the second transparent substrate 22. The TFT 24 may be turned on (closed) or off (opened) by image data provided from a panel driver 30. In addition, by turning the TFT 24 on (closing) or off (opening), an electric field may be formed or removed from between the pixel electrode 23 and the common electrode 26.

The liquid crystal layer 25 is formed between the pixel electrode 23 and the common electrode 26 and is filled with liquid crystal molecules 25a. The liquid crystal may represent an intermediate state between a solid (crystal) and a liquid. The liquid crystal may exhibit optical properties depending on a change in electric field. For example, a direction of the molecular arrangement constituting the liquid crystal may change depending on a change in electric field. As a result, optical properties of the liquid crystal layer 25 may change according to the presence or absence of the electric field passing through the liquid crystal layer 25. For example, the liquid crystal layer 25 may rotate a polarization direction of light about an optical axis according to the presence or absence of the electric field. Accordingly, the polarized light that has passed through the first polarizing film 21 is changed in polarization direction while passing through the liquid crystal layer 25, and may pass through the second polarizing film 29.

At one edge of the liquid crystal panel 20, a cable 20a through which image data is transmitted to the liquid crystal panel 20 and a display driver integrated circuit (DDI) 30 (hereinafter, referred to as the “panel driver”) that processes digital image data and outputs an analog image signal are provided.

The cable 20a may electrically connect between the circuit board CB (e.g., the main control board 50, the BLU control board 55, and/or the power board 60) and the panel driver 30, and may also electrically connect the panel driver 30 and the liquid crystal panel 20. The cable 20a may include a flexible flat cable or a film cable that may be bendable.

The panel driver 30 may receive image data and power from the circuit board CB through the cable 20a. Further, the panel driver 30 may provide image data and driving current to the liquid crystal panel 20 through the cable 20a.

In addition, the cable 20a and the panel driver 30 may be integrally implemented as a film cable, a chip on film (COF), a tape carrier package (TCP), or the like. In other words, the panel driver 30 may be disposed on the cable 20a. However, the disclosure is not limited thereto, and the panel driver 30 may be disposed on the liquid crystal panel 20.

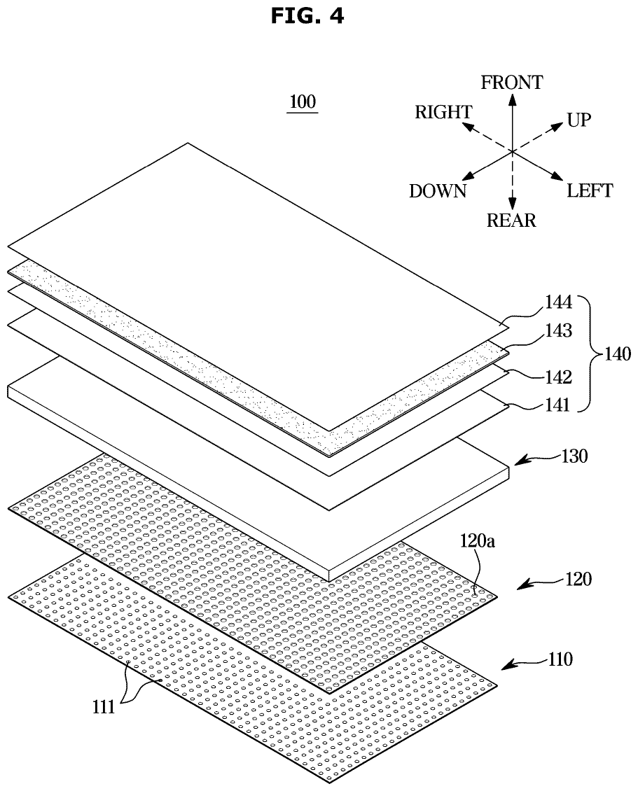

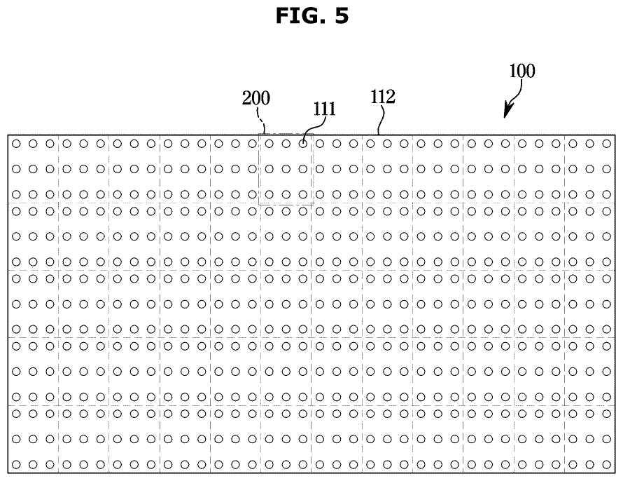

FIG. 4 illustrates an example of the backlight unit 100 included in the display apparatus 10, and FIG. 5 is a diagram illustrating that a plurality of LEDs of the backlight unit 100 that are divided into dimming blocks according to an embodiment.

As shown in FIG. 4, the backlight unit 100 may include a light source module 110 generating light, a reflector sheet 120 reflecting light, a diffuser plate 130 uniformly diffusing light, and an optical sheet 140 improving luminance of the output light.

The light source module 110 may include a plurality of light emitters 111 emitting light, and a substrate 112 supporting/fixing the plurality of light emitters 111.

The plurality of light emitters 111 may be arranged in a predetermined pattern to allow light to be emitted with uniform luminance. The plurality of light emitters 111 may be arranged to allow a distance between a single light source and each light source adjacent thereto to be the same.

For example, as shown in FIG. 4, the plurality of light emitters 111 may be aligned in rows and columns. For example, the plurality of light sources may be arranged to form an approximate square by four adjacent light sources. In addition, any one light source is disposed adjacent to four light sources, and a distance between the single light source and each of the four light sources adjacent to the single light source may be substantially the same.

Furthermore, according to embodiments, the plurality of light sources may be arranged such that three adjacent light sources form a substantially equilateral triangle. In this case, a single light source may be disposed adjacent to six light sources. In addition, a distance between the single light source and each of the six adjacent light sources may be substantially the same.

However, the arrangement in which the plurality of light emitters 111 are disposed is not limited to the arrangement described above, and the plurality of light emitters 111 may be disposed in various patterns to allow light to be emitted with uniform luminance.

Each light emitter 111 may employ a device capable of emitting monochromatic light (light having a specific range of wavelengths, for example, blue light) or white light (for example, mixed light of red light, green light, and blue light) in various directions when power is supplied. For example, the light emitter 111 may include a LED. The LED may be implemented in a variety of sizes and may include, for example, mini LEDs and/or micro LEDs.

The substrate 112 may fix the plurality of light emitters 111 to prevent positions of the light emitters 111 from being changed. In addition, the substrate 112 may supply power for enabling the light emitters 111 to emit light to the individual light emitters 111.

The substrate 112 may fix the plurality of light emitters 111, and may include a synthetic resin and/or tempered glass and/or a printed circuit board (PCB) on which a conductive power feed line for supplying power to the light emitter 111 is formed.

The reflector sheet 120 may reflect light emitted from the plurality of light emitters 111 in a forward direction or in a direction close to the forward direction.

A plurality of through holes 120a corresponding respectively to the plurality of light emitters 111 of the light source module 110 are formed in the reflector sheet 120. In addition, the light emitters 111 of the light source module 110 may pass through the through holes 120a and protrude forward of the reflector sheet 120.

For example, in an assembly process of the reflector sheet 120 and the light source module 110, the plurality of light emitters 111 of the light source module 110 are inserted into the plurality of through holes 120a formed in the reflector sheet 120. As a result, the substrate 112 of the light source module 110 is located behind the reflector sheet 120, but the plurality of light emitters 111 of the light source module 110 may be located in front of the reflector sheet 120.

Accordingly, the plurality of light emitters 111 may emit light in front of the reflector sheet 120.

The plurality of light emitters 111 may emit light in front of the reflector sheet 120 in various directions. Light may be emitted from the light emitter 111 not only toward the diffuser plate 130, but also toward the reflector sheet 120, and the reflector sheet 120 may reflect the light emitted toward the reflector sheet 120 toward the diffuser plate 130.

The light emitted from the light emitter 111 passes through various objects such as the diffuser plate 130 and the optical sheet 140. When the light passes the diffuser plate 130 and the optical sheet 140, a portion of the incident light is reflected from surfaces of the diffuser plate 130 and the optical sheet 140. The reflector sheet 120 may reflect the light reflected by the diffuser plate 130 and the optical sheet 140.

The diffuser plate 130 may be disposed in front of the light source module 110 and the reflector sheet 120, and may uniformly disperse the light emitted from the light emitter 111 of the light source module 110.

As described above, the plurality of light emitters 111 are located at various positions on a rear surface of the backlight unit 100. Although the plurality of light emitters 111 are equidistantly arranged on the rear surface of the backlight unit 100, non-uniformity of luminance may exist depending on the positions of the plurality of light emitters 111.

To eliminate the non-uniformity of luminance due to the plurality of light emitters 111, the diffuser plate 130 may diffuse the light emitted from the plurality of light emitters 111 within the diffuser plate 130. In other words, the diffuser plate 130 may uniformly emit non-uniform light from the plurality of light emitters 111 to the front surface.

The optical sheet 140 may include various sheets for improving luminance and luminance uniformity. For example, the optical sheet 140 may include a diffuser sheet 141, a first prism sheet 142, a second prism sheet 143, a reflective polarizing sheet 144, and the like.

The diffuser sheet 141 diffuses light for uniformity of luminance. The light emitted from the light emitter 111 is diffused by the diffuser plate 130, and may be diffused again by the diffuser sheet 141 included in the optical sheet 140.

The first and second prism sheets 142 and 143 may concentrate the light diffused by the diffuser sheet 141, thereby increasing the luminance. The first and second prism sheets 142 and 143 include a prism pattern of a triangular prism shape, and a plurality of these prism patterns are arranged adjacent to each other to form a plurality of bands.

The reflective polarizing sheet 144 is a kind of polarizing film, and may transmit a portion of the incident light, and reflect other portions to improve luminance. For example, the reflective polarizing sheet 144 may transmit light polarized in the same direction as a predetermined polarization direction of the reflective polarizing sheet 144 and reflect light polarized in a different direction from the polarization direction of the reflective polarizing sheet 144. In addition, the light reflected by the reflective polarizing sheet 144 is reused within the backlight unit 100, and the luminance of the display apparatus 10 may be improved by such light recycle.

The optical sheet 140 is not limited to the sheets or films shown in FIG. 4, and may further include more various sheets or films such as protective sheets.

The backlight unit 100 includes the plurality of light emitters (or light sources) 111, and may output surface light by diffusing the light emitted from the plurality of light sources 111. The liquid crystal panel 20 includes a plurality of pixels, and may control the plurality of pixels to allow each of the plurality of pixels to transmit or block light. An image may be formed by light passing through each of the plurality of pixels.

In this instance, the display apparatus 10 may perform local dimming to vary a brightness of light for each region of the backlight unit 100 in association with the output image to improve power consumption while increasing a contrast ratio.

For example, the display apparatus 10 may reduce the brightness of light of the light emitter 111 of the backlight unit 100 corresponding to a dark portion of an image to make the dark portion of the image darker, and may increase the brightness of light of the light emitter 111 of the backlight unit 100 corresponding to a bright portion of the image to make the bright portion of the image brighter. As a result, a contrast ratio or a brightness ratio of the image may be improved.

The display apparatus 10 may divide the backlight unit 100 into a plurality of blocks, and adjust current independently for each block according to an input image. Image transmission of the display apparatus 10 is performed through a method of frame-by-frame local dimming drives, and the driving of the current is adjusted according to the number of divided blocks of the light emitters 111 in the backlight unit 100.

As a result, the display apparatus 10 may effectively improve a contrast ratio by lowering a supply current to the dimming blocks of regions where the input image is dark and increasing the supply current to the dimming blocks of regions where the input image is bright.

For local dimming, the plurality of light emitters 111 included in the backlight unit 100 may be divided into a plurality of dimming blocks 200. For example, the plurality of dimming blocks 200 may be provided as a total of 60 blocks, composed of five rows and twelve columns, as shown in FIG. 5. In another example, the plurality of dimming blocks 200 may be provided as a total of 20 blocks, composed of five rows and four columns. However, the number of dimming blocks 200 is not limited to the above examples.

Referring to FIG. 5, each of the plurality of dimming blocks 200 may include at least one light emitter 111. The backlight unit 100 may supply the same driving current to the light emitters 111 belonging to the same dimming block 200, and the light emitters 111 belonging to the same dimming block 200 may emit light of the same brightness.

In addition, the backlight unit 100 may supply different driving currents to the light emitters 111 belonging to different dimming blocks 200 according to dimming data, and the light emitters 111 belonging to different dimming blocks 200 may emit light of different brightness.

As will be described below, among the light emitters 111 belonging to the same dimming block 200, different driving currents may be supplied to LEDs that output light of different colors, and the same driving current may be supplied to LEDs that output light of the same color. To this end, dimming data corresponding to one dimming block may include an RGB color value.

For example, each of the plurality of dimming blocks 200 may include N*M light sources arranged in an N*M matrix form (N and M are natural numbers). The N*M matrix refers to a matrix with N rows and M columns.

Because each of the light emitters 111 includes an LED, each of the plurality of dimming blocks 200 may include N*M LEDs. That is, each of the plurality of dimming blocks 200 may include a predetermined number of light emitters 111.

The plurality of dimming blocks 200 may be disposed on the substrate 112. That is, N*M LEDs may be disposed on the substrate 112.

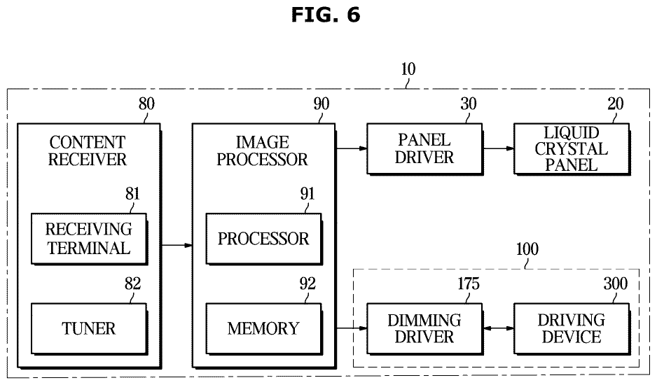

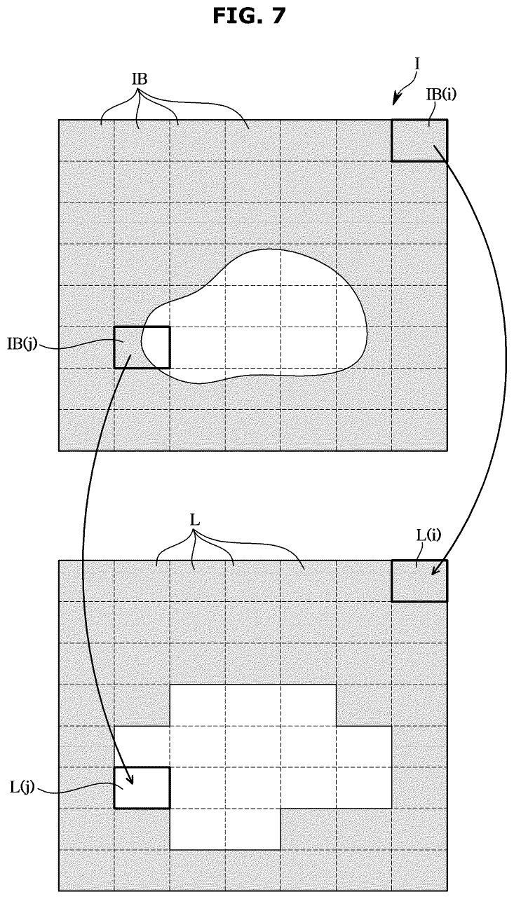

FIG. 6 is a control block diagram of a display apparatus according to an embodiment, and FIG. 7 illustrates an example in which a display apparatus converts image data into dimming data according to an embodiment.

Referring to FIG. 6, the display apparatus 10 may include a content receiver 80, an image processor 90, the panel driver 30, the liquid crystal panel 20, and the backlight unit 100. In this instance, the backlight unit 100 may include a dimming driver 175 configured to perform local dimming and a driving device 300 configured to drive the light emitter 111. The driving device 300 may be disposed on an upper surface or a lower surface of the substrate 112.

In an embodiment, the image processor 90 may be provided on the main control board 50, and the dimming driver 175 may be provided on the BLU control board 55. However, the positions of the image processor 90 and the dimming driver 175 are not limited thereto.

The content receiver 80 may include a receiving terminal 81 receiving content including a video signal and/or audio signal from content sources, and a tuner 82.

The receiving terminal 81 may receive a video signal and audio signal from content sources through a cable. For example, the receiving terminal 81 may include a component (YPbPr/RGB) terminal, a composite video blanking and sync (CVBS) terminal, an audio terminal, a high definition multimedia interface (HDMI) terminal, a universal serial bus (USB) terminal, and the like.

The tuner 82 may receive a broadcast signal from a broadcast reception antenna or a wired cable, and may extract a broadcast signal of a channel selected by a user from among broadcast signals. For example, the tuner 82 may pass a broadcast signal having a frequency corresponding to the channel selected by the user among a plurality of broadcast signals received through the broadcast reception antenna or wired cable, and may block a broadcast signal having a different frequency.

As described above, the content receiver 80 may receive an image including a video signal and an audio signal from the content sources through the receiving terminal 81 and/or the tuner 82, and may output the input image received through the receiving terminal 81 and/or the tuner 82 to the image processor 90.

The image processor 90 may include at least one processor 91 that processes an input image (image data) and a memory 92 that records/stores data.

The memory 92 stores programs and data for processing a video signal and/or an audio signal, and may temporarily remember data generated while processing the video signal and/or audio signal.

The memory 92 may include a non-volatile memory, such as read only memory (ROM) and flash memory, and a volatile memory, such as static random access memory (S-RAM) and dynamic random access memory (D-RAM).

The at least one processor 91 may receive an input image including a video signal and/or an audio signal from the content receiver 80, may decode the video signal into image data, and may generate dimming data from the image data. The image data and the dimming data may be output to the panel driver 30 and the dimming driver 175, respectively.

The at least one processor 91 may provide dimming data for local dimming to the backlight unit 100. The dimming data may include information about a luminance of each of the plurality of dimming blocks 200. For example, the dimming data may include information about an intensity of light output by the light emitters 111 included in each of the plurality of dimming blocks 200. That is, the dimming data may include information about a magnitude of current supplied to the light emitters 111 included in each of the plurality of dimming blocks 200.

The dimming data may include information about a magnitude of current supplied to each of a red LED, a green LED, and a blue LED included in the light emitter 111 included in each of the plurality of dimming blocks 200.

The at least one processor 91 may calculate an average of RGB color values of each of the plurality of dimming blocks 200 based on the image data, and may generate dimming data of each of the plurality of dimming blocks 200 based on the average of the RGB color values.

The at least one processor 91 may obtain the dimming data from the image data decoded from the video signal.

The processor 91 may convert the image data into the dimming data in various manners. For example, as shown in FIG. 7, the processor 91 may divide an image I based on the image data into a plurality of image blocks IB. The number of the plurality of image blocks IB is equal to the number of the plurality of dimming blocks 200, and the plurality of image blocks IB may each correspond to the plurality of dimming blocks 200.

The processor 91 may obtain luminance values L of the plurality of dimming blocks 200 from the image data of the plurality of image blocks IB. The luminance value L of each of the plurality of dimming blocks 200 may include an RGB color value of each of the plurality of dimming blocks 200.

The processor 91 may generate the dimming data by combining the luminance values L of the plurality of dimming blocks 200.

For example, the processor 91 may obtain a luminance value L of each of the plurality of dimming blocks 200 based on a maximum value among luminance values of pixels included in each of the image blocks IB.

A single image block includes a plurality of pixels, and image data of a single image block may include image data of a plurality of pixels (e.g., red data, green data, blue data, etc.). The processor 91 may calculate the luminance value of each of the pixels based on the image data of each of the pixels.

The processor 91 may determine a maximum value of the luminance values of pixels included in an image block as a luminance value of a dimming block corresponding to the image block. For example, the processor 91 may determine a maximum value of luminance values of pixels included in the i-th image block IB(i) as a luminance value L(i) of an i-th dimming block, and may determine a maximum value of luminance values of pixels included in a j-th image block IB(j) as a luminance value L(j) of a j-th dimming block.

The processor 91 may generate dimming data by combining the luminance values of the plurality of dimming blocks 200.

As such, the image processor 90 may decode the video signal obtained by the content receiver 80 into image data, and may generate the dimming data from the image data. In addition, the image processor 90 may transmit the image data and the dimming data to the liquid crystal panel 20 and the backlight unit 100, respectively. Transmission of dimming data from the image processor 90 to the backlight unit 100 may include transmission of the dimming data from the main control board 50 to the BLU control board 55.

The liquid crystal panel 20 includes a plurality of pixels capable of transmitting or blocking light, and the plurality of pixels are arranged in a matrix form. In other words, the plurality of pixels may be arranged in a plurality of rows and a plurality of columns.

The panel driver 30 may receive the image data from the image processor 90 and drive the liquid crystal panel 20 according to the image data. In other words, the panel driver 30 may convert image data, which is a digital signal (hereinafter, referred to as ‘digital image data’), into an analog image signal, which is an analog voltage signal, and may provide the converted analog image signal to the liquid crystal panel 20. Optical properties (e.g., light transmittance) of the plurality of pixels included in the liquid crystal panel 20 may change according to the analog image signal.

The panel driver 30 may include, for example, a timing controller, a data driver, a scan driver, and the like.

The timing controller may receive image data from the image processor 90 and output the image data and a drive control signal to the data driver and the scan driver. The drive control signal may include a scan control signal and a data control signal, and the scan control signal and the data control signal may be used to control operations of the scan driver and the data driver, respectively.

The scan driver may receive a scan control signal from the timing controller, and may input-activate any one of the plurality of rows in the liquid crystal panel 20 according to the scan control signal. In other words, the scan driver may convert pixels, included in a single row among the plurality of pixels arranged in the plurality of rows and the plurality of columns, into a state capable of receiving an analog image signal. In this instance, the other pixels input-deactivated, except for the pixels input-activated by the scan driver, may not receive an analog image signal.

The data driver may receive image data and a data control signal from the timing controller and output the image data to the liquid crystal panel 20 according to the data control signal. For example, the data driver may receive the digital image data from the timing controller and convert the digital image data into an analog image signal. In addition, the data driver may provide the analog image signal to pixels included in any one row input-activated by the scan driver. In this instance, the pixels input-activated by the scan driver receive the analog image signal, and optical properties (e.g., light transmittance) of the input-activated pixels may change according to the received analog image signal.

As described above, the panel driver 30 may drive the liquid crystal panel 20 according to image data. As a result, an image corresponding to the image data may be displayed on the liquid crystal panel 20.

The backlight unit 100 includes a plurality of light sources 111 that emit light, and the plurality of light sources 111 are arranged in a matrix form. In other words, the plurality of light sources 111 may be arranged in a plurality of rows and a plurality of columns. In addition, the backlight unit 100 may be divided into a plurality of dimming blocks 200, and each of the plurality of dimming blocks 200 may include at least one light source.

The dimming driver 175 may receive dimming data from the image processor 90 and drive the backlight unit 100 according to the dimming data. Here, the dimming data may include information about a luminance of each of the plurality of dimming blocks 200 or information about a brightness of the light sources included in each of the plurality of dimming blocks 200.

The dimming driver 175 may convert the dimming data, which is a digital signal, into an analog dimming signal, which is an analog voltage signal, and may provide the analog dimming signal to the backlight unit 100. According to the analog dimming signal, an intensity of light emitted by the light sources included in each of the plurality of dimming blocks 200 may change.

In particular, the dimming driver 175 may provide the analog dimming signal sequentially to the plurality of dimming blocks 200 by an active matrix method, instead of directly providing the analog dimming signal to all of the plurality of dimming blocks 200.

As described above, the plurality of dimming blocks 200 may be arranged in a matrix form in the backlight unit 100. In other words, the plurality of dimming blocks 200 may be arranged in a plurality of rows and a plurality of columns in the backlight unit 100.

The dimming driver 175 may provide the analog dimming signal sequentially to dimming blocks belonging to each of the plurality of rows or to dimming blocks belonging to each of the plurality of columns.

For example, the dimming driver 175 may input-activate dimming blocks belonging to any one row of the plurality of dimming blocks 200, and may provide the analog dimming signal to the input-activated dimming blocks. Thereafter, the dimming driver 175 may input-activate dimming blocks belonging to another row of the plurality of dimming blocks 200, and may provide the analog dimming signal to the input-activated dimming blocks.

The dimming driver 175 may receive the dimming data from the image processor 90 and drive the driving device 300 according to the dimming data.

The driving device 300 may control at least one dimming block among the plurality of dimming blocks 200. The driving device 300 may control the dimming block 200 based on a control signal received from the dimming driver 175.

The driving device 300 may also be referred to as a driving integrated circuit (IC) or a pixel IC in that the driving device 300 is an integrated circuit for driving at least one dimming block among the plurality of dimming blocks 200.

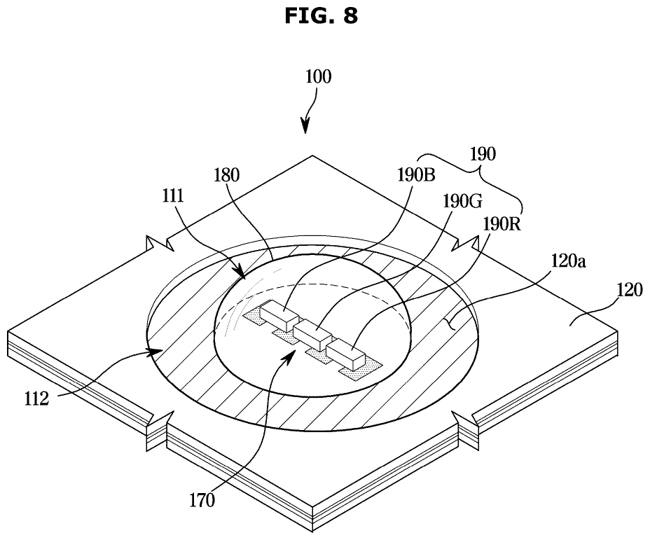

FIG. 8 illustrates an example of a light emitter included in a BLU according to an embodiment.

Referring to FIG. 8, the light emitter 111 may include at least one LED 190 (e.g., a red LED 190R, a green LED 190G, and a blue LED 190B).

The red LED 190R may include at least one red LED connected in series with each other. The green LED 190G may include at least one green LED connected in series with each other. The blue LED 190B may include at least one blue LED connected in series with each other.

A plurality of LED groups 170 may be arranged in a two-dimensional matrix form on an upper surface of the substrate 112. That is, as shown in FIG. 5, because the plurality of light emitters 111 are arranged in rows and columns, the plurality of LED groups 170 may be arranged in a two-dimensional matrix form.

In addition, according to embodiments, the plurality of light sources may be arranged such that three adjacent light sources form a substantially equilateral triangle. In this case, a single light source may be adjacent to six light sources. In addition, a distance between the single light source and each of the six adjacent light sources may be substantially the same.

However, the arrangement of the plurality of light emitters 111 is not limited to the arrangement described above, and the plurality of light emitters 111 may be arranged in various ways to emit light with uniform luminance.

The light emitter 111 may employ a device capable of emitting white light (e.g., light having a plurality of peak wavelengths, for example, mixed light of red light, green light, and blue light) in various directions when power is supplied.

That is, each light emitter 111 may emit white light by including the red LED 190R, the green LED 190G, and the blue LED 190B.

An intensity of red light emitted by the red LED 190R, an intensity of green light emitted by the green LED 190G, and an intensity of blue light emitted by the blue LED 190B may each be independently changed based on dimming data.

As shown in FIG. 8, each of the plurality of light emitters 111 may include an LED group 170 and an optical dome 180.

The backlight unit 100 may have a small thickness to allow the display apparatus 10 to have a small thickness. To reduce the thickness of the backlight unit 100, each of the plurality of light emitters 111 may have a small thickness and a simple structure.

Each LED included in each LED group 170 may include a P-type semiconductor and an N-type semiconductor to emit light by recombination of holes and electrons. In addition, the LED may include a pair of electrodes for supplying holes and electrons to the P-type semiconductor and the N-type semiconductor.

Each of the LEDs 190 (190R, 190G, and 190B) may be configured to convert electrical energy into light energy. Each of the LEDs 190R, 190G, and 190B may emit light having a maximum intensity in a predetermined wavelength based on the supplied power. For example, the blue LED 190B may emit blue light having a peak value in a wavelength (e.g., a wavelength ranging from 430 nm to 495 nm) that displays a blue color.

For example, a multilayer reflective structure in which a plurality of insulating films having different refractive indices are alternately laminated may be provided on a front surface of each of the LEDs 190R, 190G, and 190B. For example, the multilayer reflective structure may be configured as a distributed Bragg reflector (DBR). The DBR is a structure in which two or more materials having different refractive indices are alternately laminated, and may be an optical device that has high reflectivity for light of a specific wavelength according to a principle of forming an optical path difference according to a wavelength to induce strong reflection in a specific frequency band.

In addition, the LEDs 190R, 190G, and 190B of the LED group 170 may be directly attached to the substrate 112 by a chip on board (COB) method. For example, the light emitter 111 may include an LED 190 formed by attaching an LED chip or an LED die directly to the substrate 112 without separate packaging.

The LED 190 may be manufactured as a flip-chip type. The LED 190 of the flip chip type may be formed by welding, upon attaching an LED being a semiconductor device to the substrate 112, an electrode pattern of a semiconductor device as it is to the substrate 112 without using a middle medium, such as a metal lead (wire) or a ball grid array (BGA). As such, by using neither a metal lead (wire) nor a ball grid array, the light emitter 111 including the LED 190 of the flip chip type may be miniaturized.

Although the flip-chip type LED 190 welded directly to the substrate 112 by the chip on board method has been described above, the light emitter 111 is not limited to the flipchip type LED. For example, the light emitter 111 may include a package-type LED.

The optical dome 180 may cover the LED group 170. That is, the optical dome 180 may cover the red LED 190R, the green LED 190G, and the blue LED 190B included in the LED group 170.

The optical dome 180 may refract red light, green light, and blue light respectively emitted from the red LED 190R, the green LED 190G, and the blue LED 190B to mix the red light, green light, and blue light, thereby emitting white light.

As such, the optical dome 180 may emit white light by mixing red light, green light, and blue light, and reduce a distance required for mixing to white light, compared to a case in which no optical dome 180 exists, thereby reducing an optical distance (OD) required for changing point light sources to a surface light source.

In addition, the optical dome 180 may prevent or suppress the LEDs 190 from being damaged by a mechanical action from outside and/or by a chemical action.

The optical dome 180 may be in a shape of a dome resulting from cutting, for example, a sphere with a plane not including a center of the sphere, or in a shape of a hemisphere resulting from cutting a sphere with a plane including a center of the sphere. A vertical section of the optical dome 180 may be in a shape of, for example, a segment of a circle or a semicircle.

The optical dome 180 may be formed of silicon or epoxy resin. For example, th optical dome 180 may be formed by discharging molten silicon or a molten epoxy resin onto the LEDs 190 through a nozzle, etc., and then hardening the silicon or epoxy resin.

The optical dome 180 may be optically transparent or translucent. Light emitted from the LED 190 may pass through the optical dome 180 and be emitted to the outside.

In this instance, the dome-shaped optical dome 180 may refract light, like a lens. For example, light emitted from the LEDs 190 may be refracted by the optical dome 180 and dispersed.

As such, the optical dome 180 may not only protect the LEDs 190 from external mechanical action and/or chemical action or electrical action, but also disperse light emitted from the LEDs 190.

Although the optical dome 180 in the form of a silicon dome has been described above, the light emitter 111 is not limited to including the optical dome 180. For example, the light emitter 111 may include a lens for dispersing light emitted from the LEDs.

As described above, according to the disclosure, because each light emitter 111 includes the red LED 190R, the green LED 190G, and the blue LED 190B, higher color purity, a higher contrast ratio, and higher image quality may be achieved in a local dimming operation than in local dimming using single light.

The embodiments to be described below may also be applied to a self-emissive display apparatus in which a display panel itself includes the light emitter 111 (e.g., the red LED 190R, the green LED 190G, and the blue LED 190B) without a separate backlight unit.

In the disclosure, in a case where the display apparatus 10 according to an embodiment includes the backlight unit 100, ‘image data’ may refer to dimming data for driving a plurality of LEDs 190 provided in the backlight unit 100, and in a case where the display apparatus 10 according to an embodiment does not include the backlight unit 100, ‘image data’ may refer to image data for driving a plurality of LEDs 190 provided in the display panel.

In the disclosure, image data may refer to data including a color value (e.g., an RGB color value) for the light emitter 111 (e.g., the red LED 190R, the green LED 190G, and the blue LED 190B).

In the disclosure, an RGB color value may include an R value corresponding to a luminance value of the red LED 190R, a G value corresponding to a luminance value of the green LED 190G, and a B value corresponding to a luminance value of the blue LED 190B.

Each of the R value, the G value, and the B value may have a data value (or luminance value) within a predetermined range (e.g., 0 to 255) corresponding to luminance. Depending on the image data processing method, the range of each of the R value, G value, and B value included in the input data may vary (e.g., 0 to 1000).

For example, in a case where input data is defined as data received by the image processor 90 from the content receiver 80, the input data may have an input value within a first range (e.g., 0 to 255).

In another example, in a case where input data is defined as processed data obtained by processing image data by the image processor 90, the input data may have an input value within a second range different from the first range.

In the disclosure, determining driving data based on input data may include determining a value corresponding to a driving current corresponding to each of an R value, a G value, and a B value included in the input data.

In existing technologies, when driving data is determined based on input data, the LED deterioration caused by heat generated from a circuit board may not be considered.

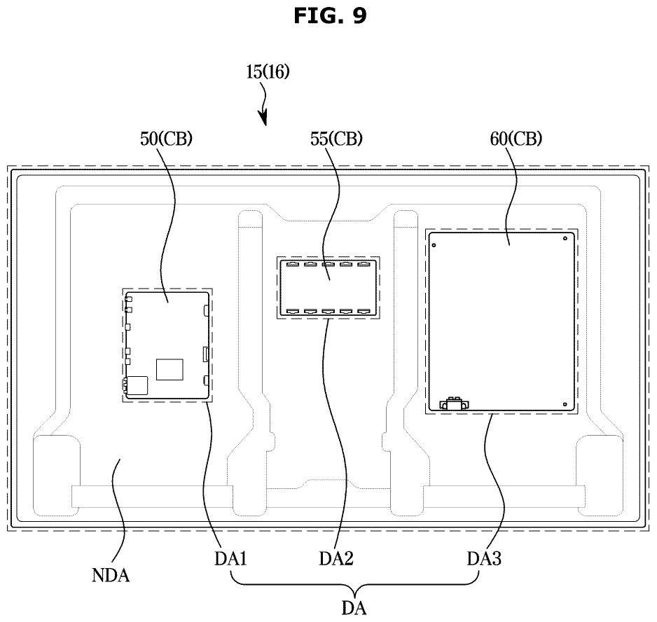

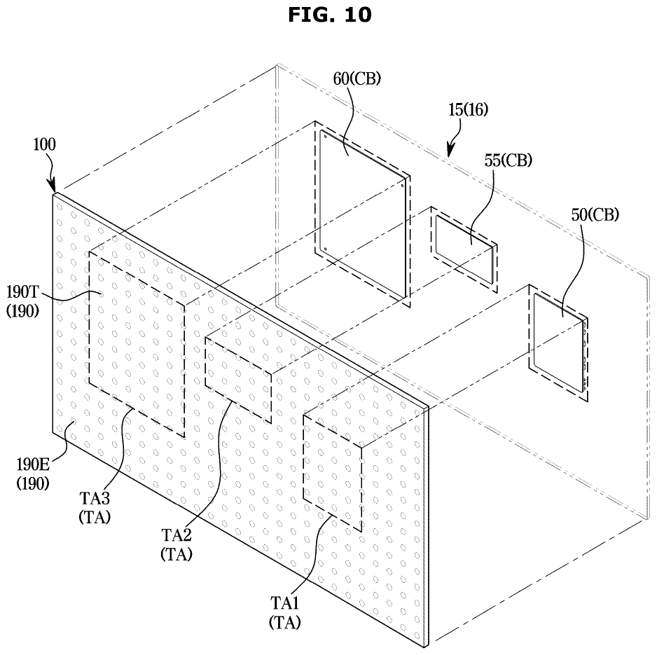

FIG. 9 illustrates an example of a circuit board mounted on a chassis of a display apparatus according to an embodiment. FIG. 10 is a diagram illustrating LEDs arranged on deterioration areas of a chassis of a display apparatus according to an embodiment.

Referring to FIG. 9 and FIG. 10, the backlight unit 100 may be provided on the chassis 15. The backlight unit 100 on the chassis 15 may refer to the backlight unit 100 in front of the chassis 15.

A circuit board CB for driving the display apparatus 10 may be mounted on the chassis 15. For example, the main control board 50, the BLU control board 55, and the power board 60 may be mounted on the chassis 15.

The circuit board CB may be provided on the rear surface of the chassis 15, and may be covered by the rear cover 16.

The circuit board CB inevitably generates heat during operation of the display apparatus 10.

In the disclosure, a region where the circuit board CB is mounted may be defined as a deterioration area DA. The deterioration area DA may be replaced with terms such as a heat generation area.

The chassis 15 may include a deterioration area DA, which is a region where the circuit board CB is mounted, and a remaining area non-deterioration area (NDA) where the circuit board CB is not mounted.

The deterioration area DA may include a plurality of distinguishable deterioration areas.

For example, the deterioration area DA may include a first deterioration area DA1 where the first circuit board 50 is mounted, a second deterioration area DA2 where the second circuit board 55 is mounted, and/or a third deterioration area DA3 where the third circuit board 60 is mounted.

The deterioration area DA may refer to the region itself where the circuit board CB is mounted on the chassis 15, or may refer to a region reduced or expanded by a predetermined ratio based on the region where the circuit board CB is mounted.

The deterioration area DA may be determined experimentally. For example, the range of the deterioration area DA may be obtained by measuring the temperature distribution of the chassis 15 after driving the display apparatus 10.

For example, after driving the display apparatus 10 for a predetermined period of time (e.g., 1 hour) under normal operating conditions, the temperature distribution of the chassis 15 may be measured using a thermal imaging camera. Through the measurement, it may be confirmed that the temperature rises around the region where the circuit board CB is mounted, and the region exceeding a predetermined reference temperature (e.g., a region 10° C. or more higher than the ambient temperature) may be defined as the deterioration area DA.

In addition, by individually measuring the temperature distribution of the region where each circuit board CB is mounted, the range of each of the first deterioration area DA1 where the first circuit board 50 is mounted, the second deterioration area DA2 where the second circuit board 55 is mounted, and/or the third deterioration area DA3 where the third circuit board 60 is mounted may be determined. Through such experimental measurements, the size and temperature distribution differences of the deterioration areas according to the heat generation characteristics of each circuit board CB may be accurately identified, which may be effectively utilized for deterioration compensation of the LED 190.

In the disclosure, the remaining area NDA excluding the deterioration area DA may be referred to as a non-deterioration area, a non-heat generation area, other regions, and the like.

The backlight unit 100 may include a plurality of LEDs 190. A portion of the plurality of LEDs 190 may be arranged on areas TA1, TA2, and TA3 corresponding respectively to the deterioration areas DA1, DA2, and DA3 described above.

In the disclosure, the LED 190 being arranged on the deterioration area DA may refer to the LED 190 being arranged on a corresponding area TA corresponding to the deterioration area DA.

When the deterioration areas DA1, DA2, and DA3 formed on the chassis 15 are projected to the front of the backlight unit 100, corresponding areas TA1, TA2, and TA3 may be formed on the backlight unit 100, respectively. For example, when the deterioration area DA1 where the first circuit board 50 is mounted is projected to the front, a first corresponding area TA1 may be formed on the backlight unit 100, when the deterioration area DA2 where the second circuit board 55 is mounted is projected to the front, a second corresponding area TA2 may be formed, and when the deterioration area DA3 where the third circuit board 60 is mounted is projected to the front, a third corresponding area TA3 may be formed.

This correspondence relationship defines, in spatial terms, the influence of the heat generated by the circuit board CB on the LEDs 190. The first corresponding region TA1 refers to a spatial range directly affected by the heat generated by the first circuit board 50, the second corresponding area TA2 refers to a spatial range directly affected by the heat generated by the second circuit board 55, and the third corresponding area TA3 refers to a spatial range directly affected by the heat generated by the third circuit board 60.

For example, the size and shape of each corresponding area TA1, TA2, and TA3 may be substantially the same as the size and shape of the corresponding deterioration area DA1, DA2, and DA3. That is, the boundary of the deterioration area DA, when projected to the front, may be the boundary of the corresponding area TA. This correspondence relationship reflects the characteristic that the heat generated by the circuit board CB is transmitted to the front.

The corresponding area TA defined as above may be utilized as a spatial reference for deterioration compensation of the LEDs 190.

When the display apparatus 10 is driven, the LEDs 190T arranged on the corresponding areas TA may deteriorate due to the heat generated by each circuit board CB. On the other hand, the LEDs 190E arranged on the remaining area NDA excluding the deterioration areas DA are relatively less affected by the heat generated by the circuit board CB.

Furthermore, the degree of deterioration of the LEDs 190T arranged on each corresponding area TA1, TA2, and TA3 may also differ depending on the heat generation characteristics of each circuit board CB.

As will be described below, according to the disclosure, luminance uniformity of the display apparatus 10 may be improved by applying a compensation algorithm for compensating for the heat generated by the circuit board CB to the LEDs 190T arranged on the deterioration area DA.

Hereinafter, for convenience of description, the LEDs 190T arranged on the deterioration area DA will be referred to as the first LED 190T, and the LEDs 190E arranged on the remaining area NDA will be referred to as the second LED 190E.

Furthermore, according to the disclosure, the luminance uniformity of the display apparatus 10 may be improved by applying different compensation algorithms to each of the plurality of deterioration areas DA, considering the temperature change characteristics of each of the plurality of deterioration areas DA.

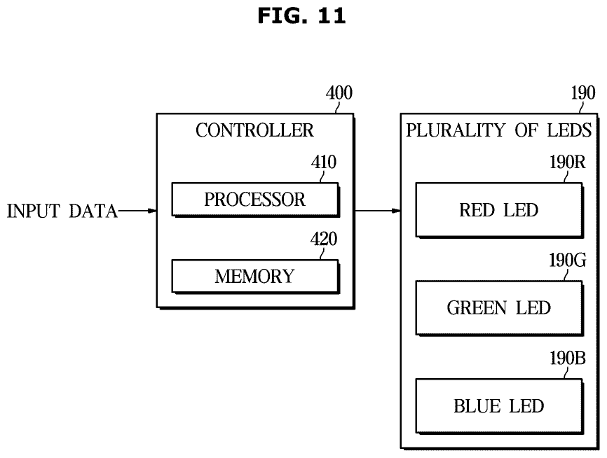

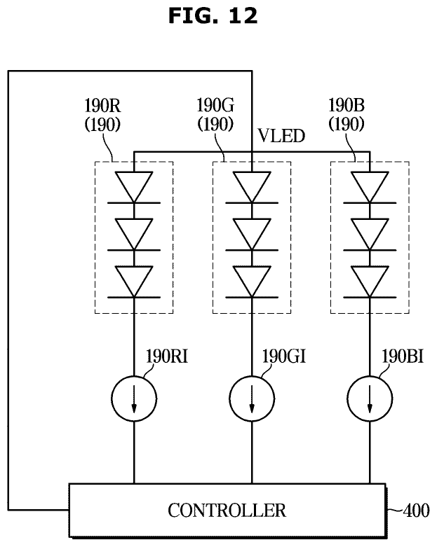

FIG. 11 illustrates components for controlling a driving current flowing through a light emitter according to an embodiment. FIG. 12 is a conceptual diagram illustrating that a controller controls an LED according to an embodiment.

Referring to FIG. 11 and FIG. 12, a controller 400 may include at least one processor 410 for controlling the plurality of LEDs 190, and at least one memory 420.

The controller 400 may include at least one component for controlling the LED 190. For example, the controller 400 may include the image processor 90, the dimming driver 175, and/or the driving device 300.

The controller 400 may control the LEDs 190 based on input data (image data).

Controlling the LED 190 based on the input data may include generating dimming data based on the input data and controlling the LED 190 based on the dimming data.

Controlling the LED 190 may include applying, to the LED 190, a driving current having a target amplitude corresponding to a color value included in the input data for a target application time corresponding to the color value included in the input data.

For example, controlling the LED 190 may include determining the driving current applied to the LED 190.

A driving algorithm for determining the target amplitude and the target application time corresponding to the color value included in the input data may be stored in the memory 420 in advance. The target amplitude and the target application time corresponding to the color value may be referred to as a PAM control value and a PWM control value, respectively. The target amplitude may also be referred to as a target magnitude, a target intensity, or the like, and the target application time may also be referred to as a target driving time, a target ON time, or the like.

The controller 400 may control a driving voltage VLED applied to an anode of LED 190. The controller 400 may control the driving voltage VLED applied to the anode of the LED 190 based on the input data. For example, in a case where the LED 190 is to emit light of high luminance, the controller 400 may increase the driving voltage VLED, compared to in a case where the LED 190 is to emit light of low luminance.

In FIG. 12, it is illustrated that the same driving voltage VLED is applied to the anodes of the red LED 190R, the green LED 190G, and the blue LED 190B. However, according to various embodiments, different driving voltages may be applied to the anodes of the red LED 190R, the green LED 190G, and the blue LED 190B.

The controller 400 may control the driving current flowing through the LED 190 in a sinking manner that adjusts the cathode side current in a state where the driving voltage is applied to the anode of the LED 190. For example, a digital-to-analog converter (DAC) that converts a digital control signal into an analog current may be embedded inside the driving device 300, which is a component of the controller 400, and the driving current flowing through the LED 190 may be controlled in a manner that the DAC supplies the analog current required for the LED 190 according to the digital input signal.

In an embodiment, the controller 400 may control the driving current flowing through the LED 190 using PWM control and/or PAM control.

In a case where the LED 190 includes the red LED 190R, the green LED 190G, and the blue LED 190B, even though the red LED 190R, the green LED 190G, and the blue LED 190B are controlled based on the same input data, the driving current 190RI of the red LED 190R, the driving current 190GI of the green LED 190G, and the driving current 190BI of the blue LED 190B may be different from each other.

For example, even though the input data includes the same R, G, and B values, the driving currents 190RI, 190GI, and 190BI required to emit light of the same luminance value from the red LED 190R, the green LED 190G, and the blue LED 190B may be different from each other.

As an example, the red LED 190R may require a driving current of 3 mA during the corresponding frame period to emit red light corresponding to a luminance value of 100, whereas the blue LED 190B may require a driving current of 2.5 mA during the corresponding frame period to emit blue light corresponding to a luminance value of 100, and the green LED 190G may require a driving current of 2 mA during the corresponding frame period to emit green light corresponding to a luminance value of 100.

As another example, the input data may include the same R, G, and B values, and accordingly, the respective driving currents required to emit light of the same luminance value from the red LED 190R, the green LED 190G, and the blue LED 190B may be different from each other.

That is, the controller 400 may control the driving current applied to the red LED 190R based on the R value included in the input data, may control the driving current applied to the green LED 190G based on the G value included in the input data, and may control the driving current applied to the blue LED 190B based on the B value included in the input data.

When the LED 190 deteriorates, the forward voltage applied to the LED 190 decreases, which increases the headroom voltage applied to the controller 400. In this instance, the remaining voltage is converted into heat, resulting in energy loss and increased heat generation.

In addition, when the LED 190 deteriorates, the forward voltage applied to the LED 190 decreases, which may lower the luminance of the LED 190 and cause a change in color coordinates.

The at least one memory 420 may store various data required to control the LEDs 190.

In an embodiment, the at least one memory 420 may store a driving algorithm for determining driving data based on input data.

The driving algorithm for determining driving data based on input data may include a mapping table in which the relationship between the input data and the driving data is mapped.

In an embodiment, the driving algorithm may include a dedicated algorithm for compensating for the deterioration of the plurality of LEDs 190 due to heat generation of the plurality of LEDs 190.

In the disclosure, the dedicated algorithm is different from the compensation algorithm to be described below, and may refer to a correction algorithm for compensating for heat generation of the plurality of LEDs 190 themselves, regardless of the heat generation of the circuit board CB.

In an embodiment, the dedicated algorithm may include a correction algorithm for compensating for heat generation of the plurality of LEDs 190 themselves, the heat generation of the plurality of LEDs 190 occurring as a turn-on period of the display apparatus 10 becomes longer.

In an embodiment, the dedicated algorithm may include a correction algorithm for compensating for heat generation of the plurality of LEDs 190 themselves based on a feedback voltage applied to a cathode of LED 190.

The feedback voltage applied to the cathode of the LED 190 may refer to the voltage applied to the cathode of the last LED 190, among at least one LED 190 connected in series, the cathode of which is not connected to another LED 190.

In an embodiment, the at least one processor 410 may determine driving data based on the driving algorithm stored in the memory 420 and the input data.

For example, the at least one processor 410 may convert the input data into driving data using the mapping table stored in the memory 420, and then control the plurality of LEDs 190 based on the driving data.

The driving data may include a driving value for controlling the plurality of LEDs 190. The driving value for controlling the plurality of LEDs 190 may include a driving current value.

The driving current value may include an amplitude value of the driving current and a duty ratio value of the driving current.

In the disclosure, an amplitude of driving current may be referred to as a magnitude of the driving current, a current value of the driving current, an intensity of the driving current, a maximum current of the driving current, and the like.

In the disclosure, a duty ratio of driving current may be referred to as a pulse width ratio of the driving current, an on-time ratio of the driving current, an operation ratio of the driving current, a pulse ratio of the driving current, and the like.

The plurality of LEDs 190 may include the red LEDs 190R, the green LEDs 190G, and the blue LEDs 190B.

The input data may include an input value for each of the red LEDs 190R, the green LEDs 190G, and the blue LEDs 190B.

The at least one processor 410 may convert the input value for each of the red LEDs 190R, the green LEDs 190G, and the blue LEDs 190B into a driving value using the mapping table stored in the memory 420, and then determine the driving current applied to each of the red LEDs 190R, the green LEDs 190G, and the blue LEDs 190B based on the driving value.

The at least one processor 410 may determine driving data based on the input data and the driving algorithm, and determine a first driving current applied to the first LED 190T and a second driving current applied to the second LED 190E based on the driving data.

Determining the driving current may refer to determining the amplitude (or magnitude) and the duty ratio of the driving current.

In an embodiment, the at least one memory 420 may store a compensation algorithm for compensating for deterioration of the first LED 190T due to heat generation of the circuit board CB among the plurality of LEDs 190.

The compensation algorithm may compensate for the deterioration of the first LED 190T based on a turn-on period of the display apparatus 10.

Compensating for the deterioration of the first LED 190T may include determining the first driving current applied to the first LED 190T based on the driving algorithm, and adjusting the first driving current by applying the compensation algorithm.

In the disclosure, the first driving current may refer to the first driving current determined based on the driving data.

In the disclosure, adjusting the first driving current may include adjusting an amplitude and/or a duty ratio of the first driving current.

Here, adjusting the amplitude of the driving current may refer to PAM control, and adjusting the duty ratio of the driving current may refer to PWM control.

The compensation algorithm may include an estimation algorithm for estimating a temperature of the circuit board CB based on a turn-on period of the display apparatus 10.

Estimating the temperature of the circuit board CB may refer to estimating the temperature of the corresponding deterioration area DA.

For example, by measuring a temperature change of the chassis 15 after driving the display apparatus 10, the temperature of the deterioration area DA corresponding to the turn-on period of the display apparatus 10 may be obtained.

The estimation algorithm may include a mapping table in which the relationship between a turn-on period of the display apparatus 10 and a temperature of a deterioration area DA is mapped.

In an embodiment, the mapping table in which the relationship between the turn-on period of the display apparatus 10 and the temperature of the deterioration area DA is mapped may include a first mapping table in which the relationship between the turn-on period of the display apparatus 10 and a temperature of the first deterioration area DA1 is mapped, a second mapping table in which the relationship between the turn-on period of the display apparatus 10 and a temperature of the second deterioration area DA2 is mapped, and/or a third mapping table in which the relationship between the turn-on period of the display apparatus 10 and a temperature of the third deterioration area DA3 is mapped.

The compensation algorithm may include an adjustment algorithm for adjusting the amplitude and the duty ratio of the first driving current based on the temperature of the deterioration area DA estimated by the estimation algorithm.

The adjustment algorithm may define a relationship between a temperature of a deterioration area DA and a correction rate of an amplitude of a driving current and/or a relationship between a temperature of a deterioration area DA and a duty ratio of a driving current.

The turn-on period of the display apparatus 10 may also be referred to as a driving time of the display apparatus 10.

The turn-on period of the display apparatus 10 may refer to a period that is measured from the time when the display apparatus 10 is turned on, and is initialized when the display apparatus 10 is turned off.

According to the disclosure, by adjusting the first driving current applied to the first LED 190T based on the compensation algorithm, the deterioration of the first LED 190T caused by heat generation of the circuit board CB may be compensated.

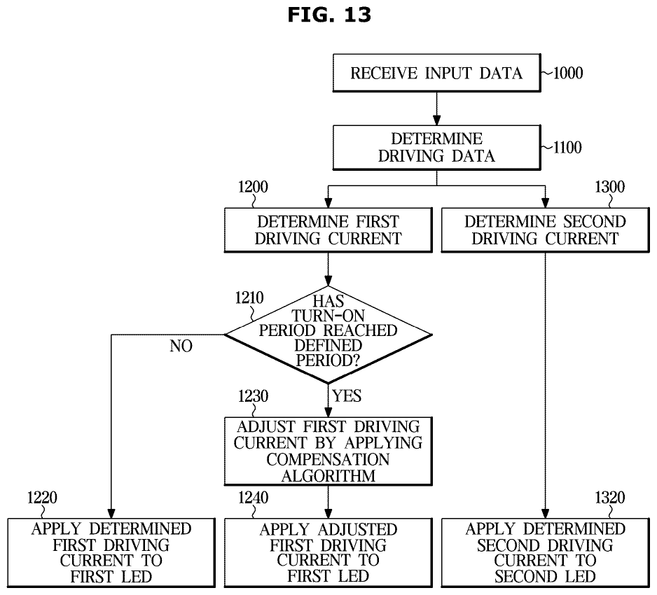

FIG. 13 is a flowchart illustrating an example method of controlling a display apparatus according to an embodiment.

Referring to FIG. 13, the at least one processor 410 may receive input data (1000). The input data may include a color value corresponding to each of the plurality of LEDs 190.

The at least one processor 410 may determine driving data corresponding to each of the plurality of LEDs 190 based on the input data and the driving algorithm (1100).

For example, the at least one processor 410 may convert the input data into driving data by applying the driving algorithm.

In an embodiment, the driving data may include a data value corresponding to an amplitude of a driving current. According to various embodiments, the driving data may further include a data value corresponding to a duty ratio of the driving current.

The at least one processor 410 may determine a driving current applied to each of the plurality of LEDs 190 based on the driving data (1200, 1300).

For example, the at least one processor 410 may determine a first driving current applied to the first LED 190T based on the driving data (1200). The at least one processor 410 may determine a second driving current applied to the second LED 190E based on the driving data (1300).

Determining the driving current applied to each of the plurality of LEDs 190 may include determining an amplitude of the driving current applied to each of the plurality of LEDs 190. According to various embodiments, in a case where the driving data further includes a data value corresponding to a duty ratio of the driving current, determining the driving current applied to each of the plurality of LEDs 190 may include determining the amplitude and the duty ratio of the driving current applied to each of the plurality of LEDs 190.

The at least one processor 410 may apply the second driving current determined in operation 1300 to the second LED 190E (1320). The second LED 190E is an LED (LEDs) 190 located on the non-deterioration area NDA, and the second driving current applied to the second LED 190E may not be adjusted by the compensation algorithm.

For example, the compensation algorithm may be used to adjust only the first driving current among the first driving current and the second driving current.

The at least one processor 410 may count (measure) a turn-on period p of the display apparatus 10 (1210). The turn-on period p of the display apparatus 10 may be measured based on the point in time at which the display apparatus 10 is turned on.

The at least one processor 410 may apply the first driving current, determined in operation 1200, to the first LED 190T (1220), based on the turn-on period of the display apparatus 10 not having exceeded a defined period (No in operation 1210).

For example, the at least one processor 410 may not adjust the first driving current by applying the compensation algorithm, based on the turn-on period of the display apparatus 10 not having exceeded the defined period (No in operation 1210).

In an embodiment, the defined period may be set in consideration of the time at which the heat generation of the circuit board CB reaches a temperature range that substantially affects the deterioration of LED 190.

For example, after the display apparatus 10 starts operating, a temperature of the circuit board CB gradually rises. When the temperature of the circuit board CB rises above a predetermined temperature (e.g., 40° C.), the light-emitting characteristics of the LEDs 190 adjacent to the circuit board significantly deteriorate.

In an embodiment, the defined period may be preset to define the time at which the temperature of the circuit board CB reaches the predetermined temperature (e.g., 40° C.).

The defined period may be determined as the period between the time at which the display apparatus 10 is turned on and the time at which the temperature of the circuit board CB reaches the predetermined temperature.

The defined period may be stored in the memory 420, and may be different for each deterioration area DA.

For example, the defined period may include a first defined period corresponding to the first deterioration area DA1, a second defined period corresponding to the second deterioration area DA2, and/or a third defined period corresponding to the third deterioration area DA3.

The first defined period may be experimentally determined as the period between the time at which the display apparatus 10 is turned on and the time at which the temperature of the first circuit board 50 reaches the predetermined temperature, the second defined period may be experimentally determined as the period between the time at which the display apparatus 10 is turned on and the time at which the temperature of the second circuit board 55 reaches the predetermined temperature, and the third defined period may be experimentally determined as the period between the time at which the display apparatus 10 is turned on and the time at which the temperature of the third circuit board 60 reaches the predetermined temperature.

In a case where a temperature rise rate of the display apparatus 10 after being turned on is fastest in the order of the third circuit board 60, the first circuit board 50, and the second circuit board 55, the third defined period may be shorter than the first defined period, and the first defined period may be shorter than the second defined period.

For example, when the display apparatus 10 is driven, it may take approximately 30 minutes for the temperature of the main control board 50 to reach 40° C., approximately 20 minutes for the temperature of the BLU control board 55 to reach 40° C., and approximately 10 minutes for the temperature of the power board 60 to reach 40° C. In this case, the defined period corresponding to each circuit board CB may be set to 30 minutes, 20 minutes, and 10 minutes, respectively.

According to an embodiment of the disclosure, by determining the time to apply the compensation algorithm based on the time at which the temperature of the circuit board CB reaches a temperature range that substantially affects the deterioration of the LED 190, the deterioration of the LED 190 may be effectively compensated.

The at least one processor 410 may adjust the first driving current by applying the compensation algorithm (1230), based on the turn-on period of the display apparatus 10 having exceeded the defined period (Yes in operation 1210).

The at least one processor 410 may apply the first driving current adjusted by applying the compensation algorithm to the first LED 190T (1240), based on the turn-on period of the display apparatus 10 having exceeded the defined period (Yes in operation 1210).

Adjusting the first driving current by applying the compensation algorithm may include adjusting the amplitude and/or the duty ratio of the first driving current based on the compensation algorithm.

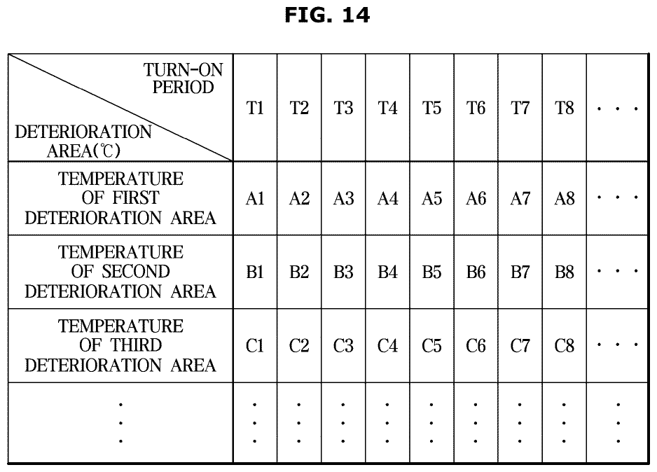

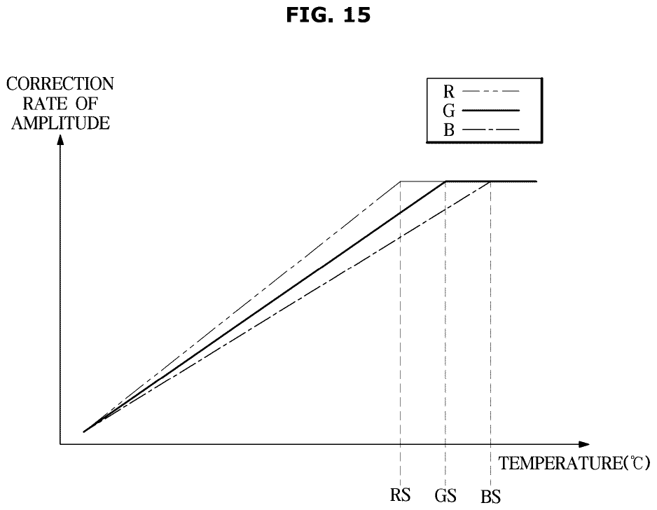

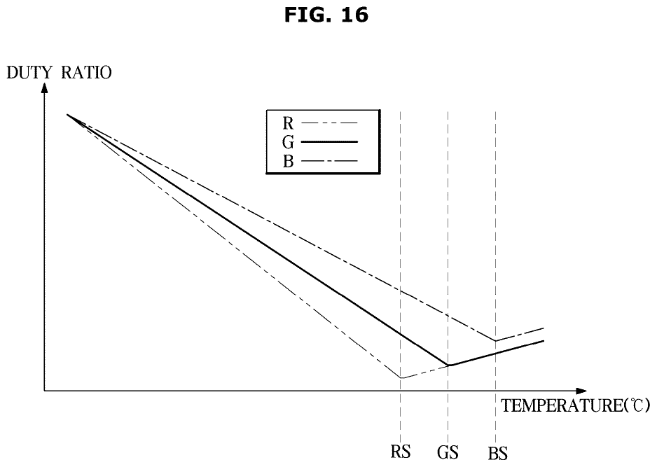

Hereinafter, an example method of adjusting the first driving current by applying the compensation algorithm is described with reference to FIG. 14, FIG. 15, and FIG. 16.

FIG. 14 illustrates an example of an estimation algorithm for estimating a temperature change of a deterioration area according to a turn-on period of a display apparatus in a compensation algorithm used by the display apparatus according to an embodiment. FIG. 15 illustrates an example of an adjustment algorithm for adjusting a correction rate of an amplitude according to a temperature change of a deterioration area in a compensation algorithm used by a display apparatus according to an embodiment. FIG. 16 illustrates an example of an adjustment algorithm for adjusting a duty ratio according to a temperature change of a deterioration area in a compensation algorithm used by a display apparatus according to an embodiment.

Referring to FIG. 14, the compensation algorithm according to an embodiment may include the estimation algorithm for estimating a temperature of the circuit board CB based on a turn-on period of the display apparatus 10. The estimation algorithm may include a mapping table in which the relationship between a turn-on period of the display apparatus 10 and a temperature of the circuit board CB (or a temperature of a deterioration area) is mapped.

At least one circuit board CB for driving the display apparatus 10 may be mounted on the chassis 15, and at least one deterioration area corresponding to the at least one circuit board CB may be formed.

The temperature of the deterioration area corresponding to the turn-on period of the display apparatus 10 may be experimentally obtained.

The temperature of the deterioration area corresponding to the turn-on period of the display apparatus 10 may be different depending on the type of the circuit board CB.

For example, the temperatures A1, A2, A3, A4, A5, A6, A7, and A8 of the first deterioration area DA1 corresponding to the turn-on periods T1, T2, T3, T4, T5, T6, T7, and T8 of the display apparatus 10 may be different from the temperatures B1, B2, B3, B4, B5, B6, B7, and B8 of the second deterioration area DA2 corresponding to the turn-on periods T1, T2, T3, T4, T5, T6, T7, and T8 of the display apparatus 10. The temperatures B1, B2, B3, B4, B5, B6, B7, and B8 of the second deterioration area DA2 corresponding to the turn-on periods T1, T2, T3, T4, T5, T6, T7, and T8 of the display apparatus 10 may be different from the temperatures C1, C2, C3, C4, C5, C6, C7, and C8 of the third deterioration area DA3 corresponding to the turn-on periods T1, T2, T3, T4, T5, T6, T7, and T8 of the display apparatus 10.

The at least one processor 410 may determine the temperature of the deterioration area DA corresponding to each of the turn-on periods T1, T2, T3, T4, T5, T6, T7, and T8 of the display apparatus 10 based on the compensation algorithm.

In an embodiment, the defined period may be predefined according to the temperatures of the deterioration area DA corresponding to the turn-on periods T1, T2, T3, T4, T5, T6, T7, and T8 of the display apparatus 10.

For example, in a case where the temperature rise rate of the display apparatus 10 after turn-on of the display apparatus 10 is fastest in the order of the third deterioration area DA3, the first deterioration area DA1, and the second deterioration area DA2, and C3, A4, and B5 are the same and correspond to the temperatures for defining the defined period, a third defined period corresponding to the third deterioration area DA3 may be T3 when the temperature of the third deterioration area DA3 reaches C3, a first defined period corresponding to the first deterioration area DA1 may be T4 when the temperature of the first deterioration area DA1 reaches A4, and a second defined period corresponding to the second deterioration area DA2 may be T5 when the temperature of the second deterioration area DA2 reaches B5.

The at least one processor 410 may adjust an amplitude and a duty ratio of the first driving current based on the temperature of the deterioration area DA determined based on the compensation algorithm.

In summary, the compensation algorithm may include a first compensation algorithm for compensating for a third driving current applied to the third LED 190 disposed in the first deterioration area DA1 among the first LED 190T, and a second compensation algorithm for compensating for a fourth driving current applied to the fourth LED 190 disposed in the second deterioration area among the first LED 190T.

The first compensation algorithm and the second compensation algorithm may be defined differently based on the differences in heat generation characteristics of the first deterioration area DA1 and the second deterioration area DA2.

The first compensation algorithm being different from the second compensation algorithm may refer to a temperature rise rate of the first deterioration area DA1 according to the turn-on period of the display apparatus 10 being different from a temperature rise rate of the second deterioration area DA2 according to the turn-on period of the display apparatus 10.

The at least one processor 410 may determine the third driving current applied to the third LED 190 and the fourth driving current applied to the fourth LED 190 based on the driving data. In addition, the at least one processor 410 may adjust the third driving current by applying the first compensation algorithm based on the turn-on period of the display apparatus 10 having exceeded the first defined period, and adjust the fourth driving current by applying the second compensation algorithm based on the turn-on period of the display apparatus 10 having exceeded the second defined period.

Referring to FIG. 15, the compensation algorithm may include a mapping table in which the relationship between a temperature of a deterioration area DA and a correction rate of an amplitude of the first driving current is mapped.

In the disclosure, the correction rate of the amplitude may refer to an increase rate of the amplitude. For example, the correction rate of the amplitude is 1.01, which may refer to the increase rate of the amplitude being 1%.

The at least one processor 410 may determine the correction rate of the amplitude corresponding to the temperature of the deterioration area DA based on the compensation algorithm.

In an embodiment, the at least one processor 410 may increase the correction rate of the amplitude of the first driving current as the temperature of the circuit board CB corresponding to the turn-on period of the display apparatus 10 increases to a defined saturation temperature.

The at least one processor 410 may adjust the amplitude of the first driving current by applying the correction rate of the amplitude corresponding to the temperature of the deterioration area DA to the amplitude of the first driving current.

In an embodiment, the at least one processor 410 may maintain the correction rate of the amplitude of the first driving current at a defined maximum correction rate, based on the temperature of the circuit board CB corresponding to the turn-on period of the display apparatus 10 being greater than or equal to a defined saturation temperature.

As the temperature of the deterioration area DA increases, the correction rate of the amplitude may also increase.

The increase rate of the amplitude correction rate (the correction rate of the amplitude) according to the temperature rise rate of the deterioration area DA may be preset based on the deterioration characteristics of the LED 190.

The LED 190 has a characteristic that its light emission efficiency decreases as its temperature rises. Accordingly, as the temperature of the deterioration area DA rises, the light emission efficiency of the first LED 190T disposed in the deterioration area gradually decreases.

According to the disclosure, the at least one processor 410 increases the amplitude of the first driving current to compensate for the decrease in light emission efficiency of the first LED 190T disposed in the corresponding area as the temperature of the deterioration area DA rises.

For example, in a case where it is confirmed that the light emission efficiency of the LED 190T decreases by approximately 5% every time the temperature of the deterioration area DA rises by 10° C., the correction algorithm may be designed to increase the amplitude of the first driving current applied to the LED 190T by approximately 5% every time the temperature of the deterioration area DA rises by 10° C.

Increasing the amplitude of the first driving current by approximately 5% may refer to, for example, adjusting the amplitude of the first driving current to 105 mA in a case where the amplitude of the first driving current is determined to be 100 mA.

According to the disclosure, through the above-described amplitude compensation, the decrease in light emission efficiency of the LED 190T due to temperature changes in the deterioration area DA may be effectively compensated for, thereby improving the luminance uniformity of the display apparatus 10.

The first LED 190T may include the red LED 190, the green LED 190, and the blue LED 190.

The red LED 190, the green LED 190, and the blue LED 190 have different deterioration characteristics with increasing temperature, and thus different amplitude correction rates require to be applied.

For example, when the temperature of the deterioration area DA rises, the light emission efficiency of the red LED 190 decreases the most, followed by the light emission efficiency of the green LED 190, and the light emission efficiency of the blue LED 190 decreases relatively the least. For example, in a case where the temperature of the deterioration area DA rises by 10° C., the light emission efficiency of the red LED 190 may decrease by approximately 8%, the light emission efficiency of the green LED 190 may decrease by approximately 5%, and the light emission efficiency of the blue LED 190 may decrease by approximately 3%.

The correction algorithm may be designed by reflecting the deterioration characteristics of each of the red LED 190, the green LED 190, and the blue LED 190, such that increase coefficients of the amplitude correction rate with increasing temperature corresponding to the red LED 190, the green LED 190, and the blue LED 190 are different from each other.

The increase coefficients of the amplitude correction rate with increasing temperature of the circuit board CB may include a first increase coefficient corresponding to the red LED 190, a second increase coefficient corresponding to the green LED 190, and a third increase coefficient corresponding to the blue LED 190. Here, the first increase coefficient may be greater than the second increase coefficient, and the second increase coefficient may be greater than the third increase coefficient.

The increase coefficient of the amplitude correction rate with increasing temperature of the circuit board CB may refer to an increase coefficient of an amplitude correction rate with increasing temperature of a deterioration area.

The increase coefficient of the amplitude correction rate with increasing temperature of the deterioration area may refer to a slope between the temperature of the deterioration area and the amplitude correction rate.

Meanwhile, in a case where the first driving current continuously increases as the temperature of the deterioration area DA rises, the deterioration of the first LED 190T may be accelerated, leading to a vicious cycle.

Accordingly, an upper limit (defined maximum correction rate) for the correction rate of the amplitude of the first driving current requires to be set to prevent the first driving current from continuously increasing.

For example, the upper limit of the correction rate of the amplitude of the first driving current may be set to 15%, but is not limited thereto.

The compensation algorithm may maintain the correction rate of the amplitude at the maximum correction rate even though the temperature of the first LED 190T rises, once the correction rate of the amplitude of the first driving current reaches the defined maximum correction rate.

To this end, the compensation algorithm may be designed to maintain the correction rate of the amplitude of the first driving current at the defined maximum correction rate in a case where the temperature of the deterioration area DA is greater than or equal to a defined saturation temperature.

Depending on the deterioration characteristics of each of the red LED 190, the green LED 190, and the blue LED 190, the defined saturation temperatures corresponding to each of the red LED 190, the green LED 190, and the blue LED 190 may be different from each other.

For example, because the first increase coefficient corresponding to the red LED 190 is greater than the second increase coefficient corresponding to the green LED 190, and the second increase coefficient is greater than the third increase coefficient corresponding to the blue LED 190, a saturation temperature RS of the red LED 190 may be the lowest, followed by a saturation temperature GS of the green LED 190, and a saturation temperature BS of the blue LED 190 may be the highest.

For example, the defined saturation temperature may include a first saturation temperature corresponding to the red LED 190, a second saturation temperature corresponding to the green LED 190, and a third saturation temperature corresponding to the blue LED 190, and the first saturation temperature may be lower than the second saturation temperature, and the second saturation temperature may be lower than the third saturation temperature.

According to the disclosure, by limiting the amplitude of the first driving current to the defined maximum correction rate in response to the temperature of the deterioration area DA reaching the defined saturation temperature, the acceleration of deterioration of the LED 190 due to the continuous increase of the first driving current may be prevented.

Referring to FIG. 16, the compensation algorithm may include a mapping table in which the relationship between a temperature of a deterioration area DA and a duty ratio of the first driving current is mapped.

In the disclosure, the duty ratio may refer to an on/off ratio of the LED 190. For example, in a case where the duty ratio is 0.8, this may indicate that, within a single period of applying the first driving current, the ratio of the current application time to the current non-application time is 8:2.

The at least one processor 410 may determine the duty ratio corresponding to the temperature of the deterioration area DA based on the compensation algorithm.

In an embodiment, the at least one processor 410 may increase a duty ratio of the first driving current as the temperature of the circuit board CB corresponding to the turn-on period of the display apparatus 10 increases to a defined saturation temperature.

The at least one processor 410 may adjust the duty ratio of the first driving current to the duty ratio corresponding to the temperature of the deterioration area DA.

In an embodiment, the at least one processor 410 may adjust the duty ratio of the first driving current to a defined lowest duty ratio, based on the temperature of the circuit board CB corresponding to the turn-on period of the display apparatus 10 reaching the defined saturation temperature.

In an embodiment, the duty ratio of the first driving current may be increased based on the defined lowest duty ratio, based on the temperature of the circuit board CB corresponding to the turn-on period of the display apparatus 10 being greater than or equal to the defined saturation temperature.

As the temperature of the deterioration area DA increases, the duty ratio of the first driving current may decrease.

The decrease rate of the duty ratio according to the temperature rise rate of the deterioration area DA may be preset by reflecting the deterioration characteristics of the LED 190.

The LED 190 has a characteristic that its light emission efficiency decreases as its temperature rises. Accordingly, as the temperature of the deterioration area DA rises, the light emission efficiency of the first LED 190T disposed in the deterioration area gradually decreases.

However, the deterioration of the first LED 190T may be accelerated by increasing the amplitude of the first driving current to compensate for the decrease in light emission efficiency of the first LED 190T disposed in the corresponding area as the temperature of the deterioration area DA rises. That is, as the duty ratio of the first driving current within a single period of applying the first driving current increases, the turn-off period of the first LED 190T becomes shorter, and thus the deterioration of the first LED 190T may be accelerated.

Accordingly, the acceleration of deterioration of the first LED 190T requires to be prevented by increasing the turn-off period of the first LED 190T by decreasing the duty ratio as the temperature of the deterioration area DA rises.

According to the disclosure, through the above-described duty ratio compensation, the deterioration of the first LED 190T may be prevented from being accelerated as the amplitude of the first driving current applied to the first LED 190T increases.

The first LED 190T may include the red LED 190, the green LED 190, and the blue LED 190.

Because the red LED 190, the green LED 190, and the blue LED 190 have different deterioration characteristics with increasing temperature, different correction rates of amplitude are applied, and thus different duty ratios require to be applied.

A duty ratio decrease coefficient with increasing temperature of the circuit board CB may include a first decrease coefficient corresponding to the first red LED 190, a second decrease coefficient corresponding to the first green LED 190, and a third decrease coefficient corresponding to the first blue LED 190.

Because the first increase coefficient corresponding to the red LED 190 is greater than the second increase coefficient corresponding to the green LED 190 and the second increase coefficient corresponding to the green LED 190 is greater than the third increase coefficient corresponding to the blue LED 190, the first decrease coefficient may be greater than the second decrease coefficient, and the second decrease coefficient may be greater than the third decrease coefficient.

The duty ratio decrease coefficient with increasing temperature of the circuit board CB may refer to a duty ratio decrease coefficient with increasing temperature of a deterioration area.

The duty ratio decrease coefficient with increasing temperature of the deterioration area may refer to a slope between the temperature of the deterioration area and the duty ratio. A large decrease coefficient may refer to a large decrease in the duty ratio compared to the temperature change of the deterioration area. That is, the duty ratio decrease coefficient with increasing temperature of the deterioration area may refer to a magnitude of the slope between the temperature of the deterioration area and the duty ratio.

Meanwhile, in a case where the correction rate of the amplitude of the first driving current is maintained at a defined maximum correction rate as the temperature of the deterioration area DA rises, the decrease in the light emission efficiency of the LED 190T may not be effectively compensated for in terms of luminance compensation. As a result, the luminance uniformity of the display apparatus 10 may be reduced.

Accordingly, by increasing the duty ratio once the correction rate of the amplitude of the first driving current reaches the defined maximum correction rate, the light emission efficiency of the LED 190T requires to be increased.

For example, the compensation algorithm may be designed to adjust the duty ratio of the first driving current to the defined lowest duty ratio based on the temperature of the circuit board CB corresponding to the turn-on period of the display apparatus 10 reaching the defined saturation temperatures RS, BS, and GS, and to increase the duty ratio of the first driving current as the temperature of the circuit board CB corresponding to the turn-on period of the display apparatus 10 increases from the defined saturation temperatures RS, BS, and GS.

Meanwhile, the defined lowest duty ratio may be predetermined based on the relationship between the decrease coefficient and the defined saturation temperature RS.

For example, the defined lowest duty ratio may include a first duty ratio corresponding to the first red LED 190, a second duty ratio corresponding to the first green LED 190, and a third duty ratio corresponding to the first blue LED 190. Here, the first duty ratio may be less than the second duty ratio, and the second duty ratio may be less than the third duty ratio.

According to the disclosure, the luminance reduction of the LED 190 may be prevented, while preventing the acceleration of deterioration of the LED 190.

According an embodiment of the disclosure, a display apparatus 10 may include: a chassis 15 on which a circuit board CB configured to drive the display apparatus 10 is mounted; a backlight unit 100 arranged on the chassis 15 and including a plurality of light-emitting diodes (LEDs) 190 including a first LED 190T arranged on a deterioration area where the circuit board CB is mounted and a second LED 190E arranged on a remaining area excluding the deterioration area; memory 420 configured to store a driving algorithm for driving the plurality of LEDs 190 and a compensation algorithm for compensating for deterioration of the first LED 190T of the plurality of LEDs 190 due to heat generation of the circuit board CB; and a at least one processor 410 configured to: determine driving data based on input data and the driving algorithm, determine a first driving current applied to the first LED 190T and a second driving current applied to the second LED 190E based on the driving data, and adjust the first driving current by applying the compensation algorithm based on a turn-on period of the display apparatus 10 having exceeded a defined period.

In adjusting the first driving current, the at least one processor 410 may be configured to increase a correction rate of an amplitude of the first driving current as a temperature of the circuit board CB corresponding to the turn-on period of the display apparatus 10 increases to a defined saturation temperature RS, GS, and BS.

The at least one processor 410 may be configured to maintain the correction rate of the amplitude of the first driving current at a defined maximum correction rate, based on the temperature of the circuit board CB corresponding to the turn-on period of the display apparatus 10 being greater than or equal to the defined saturation temperature.

The first LED 190T may include a first red LED 190, a first green LED 190, and a first blue LED 190.

An increase coefficient of the correction rate of the amplitude according to an increase in the temperature of the circuit board CB may include a first increase coefficient corresponding to the first red LED 190, a second increase coefficient corresponding to the first green LED 190, and a third increase coefficient corresponding to the first blue LED 190, and the first increase coefficient may be greater than the second increase coefficient, and the second increase coefficient may be greater than the third increase coefficient.

In adjusting the first driving current, the at least one processor 410 may be configured to decrease a duty ratio of the first driving current as a temperature of the circuit board CB corresponding to the turn-on period of the display apparatus 10 increases to a defined saturation temperature.

The at least one processor 410 may be configured to adjust the duty ratio of the first driving current to a defined lowest duty ratio, based on the temperature of the circuit board CB corresponding to the turn-on period of the display apparatus 10 reaching the defined saturation temperature, and increase the duty ratio of the first driving current as the temperature of the circuit board CB corresponding to the turn-on period of the display apparatus 10 increases from the defined saturation temperature.

A decrease coefficient of the duty ratio according to an increase in the temperature of the circuit board CB may include a first decrease coefficient corresponding to the first red LED 190, a second decrease coefficient corresponding to the first green LED 190, and a third decrease coefficient corresponding to the first blue LED 190, and the first decrease coefficient may be greater than the second decrease coefficient, and the second decrease coefficient may be greater than the third decrease coefficient.

The defined lowest duty ratio may include a first duty ratio corresponding to the first red LED 190, a second duty ratio corresponding to the first green LED 190, and a third duty ratio corresponding to the first blue LED 190, and the first duty ratio may be less than the second duty ratio, and the second duty ratio may be less than the third duty ratio.

The defined saturation temperature RS, GS and BS may include a first saturation temperature RS corresponding to the first red LED 190, a second saturation temperature GS corresponding to the first green LED 190, and a third saturation temperature BS corresponding to the first blue LED 190, and the first saturation temperature RS may be lower than the second saturation temperature GS, and the second saturation temperature GS may be lower than the third saturation temperature BS.

The circuit board CB may include a first circuit board 50 and a second circuit board 55, the deterioration area may include a first deterioration area DA1 where the first circuit board 50 is mounted and a second deterioration area DA2 where the second circuit board 55 is mounted, the first LED 190T may include a third LED 190 arranged on the first deterioration area DA1 and a fourth LED 190 arranged on the second deterioration area DA2, the compensation algorithm may include a first compensation algorithm corresponding to the first deterioration area DA1 and a second compensation algorithm corresponding to the second deterioration area DA2.

The first compensation algorithm and the second compensation algorithm may be defined differently from each other based on differences in heat generation characteristics of the first deterioration area DA1 and the second deterioration area DA2.

The at least one processor 410 may be configured to: determine a third driving current applied to the third LED 190 and a fourth driving current applied to the fourth LED 190 based on the driving data, adjust the third driving current by applying the first compensation algorithm based on the turn-on period of the display apparatus 10 having exceeded a first defined period, and adjust the fourth driving current by applying the second compensation algorithm based on the turn-on period of the display apparatus 10 having exceeded a second defined period.

The first defined period and the second defined period may be defined differently based on differences in heat generation characteristics of the first deterioration area DA1 and the second deterioration area DA2.

The driving algorithm may include a dedicated algorithm for compensating for deterioration of the plurality of LEDs 190 due to heat generation of the plurality of LEDs 190.

The compensation algorithm may include: an estimation algorithm for estimating a temperature of the circuit board CB based on the turn-on period of the display apparatus 10; and an adjustment algorithm for adjusting an amplitude and a duty ratio of the first driving current based on the estimated temperature of the circuit board CB.

The compensation algorithm may be used to adjust only the first driving current among the first driving current and the second driving current.

According an embodiment of the disclosure, a method of controlling a display apparatus 10 may include: determining driving data based on input data and a driving algorithm; determining a first driving current applied to the first LED and a second driving current applied to the second LED based on the driving data; and adjusting the first driving current by applying a compensation algorithm based on a turn-on period of the display apparatus having exceeded a defined period.

The determining of the first driving current may include increasing a correction rate of an amplitude of the first driving current as a temperature of the circuit board CB corresponding to the turn-on period of the display apparatus 10 increases to a defined saturation temperature.

The determining of the first driving current may further include maintaining the correction rate of the amplitude of the first driving current at a defined maximum correction rate, based on the temperature of the circuit board CB corresponding to the turn-on period of the display apparatus 10 being greater than or equal to the defined saturation temperature.

The determining of the first driving current may include decreasing a duty ratio of the first driving current as a temperature of the circuit board CB corresponding to the turn-on period of the display apparatus 10 increases to a defined saturation temperature.

The determining of the first driving current may further include: adjusting the duty ratio of the first driving current to a defined lowest duty ratio, based on the temperature of the circuit board CB corresponding to the turn-on period of the display apparatus 10 reaching the defined saturation temperature, and increasing the duty ratio of the first driving current as the temperature of the circuit board CB corresponding to the turn-on period of the display apparatus 10 increases from the defined saturation temperature.

The determining of the first driving current applied to the first LED 190T based on the driving data may include determining a third driving current applied to the third LED 190 and a fourth driving current applied to the fourth LED 190 based on the driving data.

The determining of the first driving current may include: adjusting the third driving current by applying the first compensation algorithm based on the turn-on period of the display apparatus 10 having exceeded a first defined period, and adjusting the fourth driving current by applying the second compensation algorithm based on the turn-on period of the display apparatus 10 having exceeded a second defined period.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be a Read Only Memory (ROM), a Random Access Memory (RAM), a magnetic tape, a magnetic disk, a flash memory, an optical data storage device, etc.

Furthermore, the computer-readable recording medium may be provided in the form of a non-transitory storage medium. The term ‘non-transitory storage medium’ may refer to a tangible device without including a signal (e.g., electromagnetic waves) and may not distinguish between storing data in the storage medium semi-permanently and temporarily. For example, the non-transitory storage medium may include a buffer that temporarily stores data.

The method according to the various embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., play store™), directly between two user devices (e.g., smartphones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. A display apparatus, comprising:
a chassis having a first area and a second area;
one or more circuit boards mounted on the chassis in the first area and configured to drive the display apparatus, wherein the one or more circuit boards is not mounted in the second area;
a backlight unit arranged on the chassis and comprising a plurality of light-emitting diodes (LEDs) including one or more first LEDs arranged on the first area and a second LED arranged on the second area;
memory configured to store a driving algorithm for driving the plurality of LEDs and a compensation algorithm for compensating for deterioration of the one or more first LEDs of the plurality of LEDs due to heat generation of the one or more circuit boards; and
at least one processor configured to:
determine driving data based on input data and the driving algorithm,
based on the driving data, determine a first driving current applied to the one or more first LEDs and a second driving current applied to the second LED, and
adjust the first driving current by applying the compensation algorithm based on a turn-on period of the display apparatus having exceeded a defined period.

2. The display apparatus of claim 1, wherein, in the adjusting the first driving current, the at least one processor is further configured to increase a correction rate of an amplitude of the first driving current as a temperature of the one or more circuit boards corresponding to the turn-on period of the display apparatus increases to a defined saturation temperature.

3. The display apparatus of claim 2, wherein the at least one processor is further configured to maintain the correction rate of the amplitude of the first driving current at a defined maximum correction rate, wherein maintaining the correction rate is based on the temperature of the one or more circuit boards corresponding to the turn-on period of the display apparatus being greater than or equal to the defined saturation temperature.

4. The display apparatus of claim 2, wherein
the one or more first LEDs comprises a first red LED, a first green LED, and a first blue LED,
an increase coefficient of the correction rate of the amplitude according to an increase in the temperature of the one or more circuit boards includes a first increase coefficient corresponding to the first red LED, a second increase coefficient corresponding to the first green LED, and a third increase coefficient corresponding to the first blue LED, and
the first increase coefficient is greater than the second increase coefficient, and the second increase coefficient is greater than the third increase coefficient.

5. The display apparatus of claim 1, wherein, in the adjusting the first driving current, the at least one processor is further configured to decrease a duty ratio of the first driving current as a temperature of the one or more circuit boards corresponding to the turn-on period of the display apparatus increases to a defined saturation temperature.

6. The display apparatus of claim 5, wherein the at least one processor is further configured to:
adjust the duty ratio of the first driving current to a defined lowest duty ratio, based on the temperature of the one or more circuit boards corresponding to the turn-on period of the display apparatus reaching the defined saturation temperature, and
increase the duty ratio of the first driving current as the temperature of the one or more circuit boards corresponding to the turn-on period of the display apparatus increases from the defined saturation temperature.

7. The display apparatus of claim 5, wherein the one or more first LEDs comprises a first red LED, a first green LED, and a first blue LED,
a decrease coefficient of the duty ratio according to an increase in the temperature of the one or more circuit boards includes a first decrease coefficient corresponding to the first red LED, a second decrease coefficient corresponding to the first green LED, and a third decrease coefficient corresponding to the first blue LED, and
the first decrease coefficient is greater than the second decrease coefficient, and the second decrease coefficient is greater than the third decrease coefficient.

8. The display apparatus of claim 6, wherein the one or more first LEDs comprises a first red LED, a first green LED, and a first blue LED,
the defined lowest duty ratio includes a first duty ratio corresponding to the first red LED, a second duty ratio corresponding to the first green LED, and a third duty ratio corresponding to the first blue LED, and
the first duty ratio is less than the second duty ratio, and the second duty ratio is less than the third duty ratio.

9. The display apparatus of claim 2, wherein the one or more first LEDs comprises a first red LED, a first green LED, and a first blue LED,
the defined saturation temperature includes a first saturation temperature corresponding to the first red LED, a second saturation temperature corresponding to the first green LED, and a third saturation temperature corresponding to the first blue LED, and
the first saturation temperature is lower than the second saturation temperature, and the second saturation temperature is lower than the third saturation temperature.

10. The display apparatus of claim 1, wherein
the one or more circuit boards comprises a first circuit board and a second circuit board,
the first area includes a third area where the first circuit board is mounted and a fourth area where the second circuit board is mounted,
the one or more first LEDs comprises a third LED arranged on the third area and a fourth LED arranged on the fourth area,
the compensation algorithm includes a first compensation algorithm corresponding to the third area and a second compensation algorithm corresponding to the fourth area, and
the first compensation algorithm and the second compensation algorithm are defined differently from each other based on differences in heat generation characteristics of the third area and the fourth area.

11. The display apparatus of claim 10, wherein the defined period comprises a first defined period and a second defined period, and wherein the at least one processor is further configured to:
based on the driving data, determine a third driving current applied to the third LED and a fourth driving current applied to the fourth LED,
adjust the determined third driving current by applying the first compensation algorithm based on the turn-on period of the display apparatus having exceeded the first defined period, and
adjust the determined fourth driving current by applying the second compensation algorithm based on the turn-on period of the display apparatus having exceeded the second defined period,
wherein the first defined period and the second defined period are defined differently based on differences in heat generation characteristics of the third area and the fourth area.

12. The display apparatus of claim 1, wherein the driving algorithm includes a dedicated algorithm for compensating for deterioration of the plurality of LEDs due to heat generation of the plurality of LEDs.

13. The display apparatus of claim 1, wherein the compensation algorithm comprises:
an estimation algorithm for estimating a temperature of the one or more circuit boards based on the turn-on period of the display apparatus; and
an adjustment algorithm for adjusting an amplitude and a duty ratio of the first driving current based on the estimated temperature of the one or more circuit boards.

14. The display apparatus of claim 1, wherein the compensation algorithm is used to adjust only the first driving current among the first driving current and the second driving current.

15. A method for controlling a display apparatus including a chassis having a first area and a second area; a circuit board mounted on the chassis in the first area and configured to drive the display apparatus, and a backlight unit arranged on the chassis and including a plurality of light-emitting diodes (LEDs) including one or more first LEDs arranged on the first area and a second LED arranged on the second area, wherein the circuit board is not mounted in the second area, the method comprising:
determining driving data based on input data and a driving algorithm;
based on the driving data, determining a first driving current applied to the one or more first LEDs and a second driving current applied to the second LED; and
adjusting the first driving current by applying a compensation algorithm based on a turn-on period of the display apparatus having exceeded a defined period.

16. The method of claim 15, wherein the adjusting of the first driving current comprises increasing a correction rate of an amplitude of the first driving current as a temperature of the one or more circuit boards corresponding to the turn-on period of the display apparatus increases to a defined saturation temperature.

17. The method of claim 16, wherein the adjusting of the first driving current further comprises maintaining the correction rate of the amplitude of the first driving current at a defined maximum correction rate, wherein maintaining the correction rate is based on the temperature of the one or more circuit boards corresponding to the turn-on period of the display apparatus being greater than or equal to the defined saturation temperature.

18. The method of claim 15, wherein the adjusting of the first driving current comprises decreasing a duty ratio of the first driving current as a temperature of the one or more circuit boards corresponding to the turn-on period of the display apparatus increases to a defined saturation temperature.

19. The method of claim 18, wherein the adjusting of the first driving current further comprises:
adjusting the duty ratio of the first driving current to a defined lowest duty ratio, based on the temperature of the one or more circuit boards corresponding to the turn-on period of the display apparatus reaching the defined saturation temperature; and
increasing the duty ratio of the first driving current as the temperature of the one or more circuit boards corresponding to the turn-on period of the display apparatus increases from the defined saturation temperature.

20. The method of claim 15, wherein
the one or more circuit boards comprises a first circuit board and a second circuit board,
the first area includes a third area where the first circuit board is mounted and a fourth area where the second circuit board is mounted,
the one or more first LEDs comprises a third LED arranged on the third area and a fourth LED arranged on the fourth area,
the compensation algorithm includes a first compensation algorithm corresponding to the third area and a second compensation algorithm corresponding to the fourth area,
the determining of the first driving current comprises determining a third driving current applied to the third LED and a fourth driving current applied to the fourth LED,
the defined period comprises a first defined period and a second defined period, and
the adjusting of the first driving current comprises:
adjusting the determined third driving current by applying the first compensation algorithm based on the turn-on period of the display apparatus having exceeded the first defined period, and
adjusting the determined fourth driving current by applying the second compensation algorithm based on the turn-on period of the display apparatus having exceeded the second defined period.
